(19) United States
(12) Patent Application Publication
(10) Pub. No.: US 2007/0071910 A1
(43) Pub. Date: Mar. 29, 2007

(54) Organic insulating film having controlled molecular orientation, and adhesive film, flexible metal-clad laminate, multilayer flexible metal-clad laminate, coverlay film, tab tape, and COF base tape including the organic insulating film

(75) Inventors: Kazuhiro Ono, Shige (JP); Kan Fujihara, Shiga (JP); Takaaki Matsuwaki, Shizuoka (JP); Toshihisa Itoh, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka-shi (JP)

(21) Appl. No.: 11/514,337

(22) Filed: Sep. 1, 2006

Related U.S. Application Data
(63) Continuation-in-part of application No. PCT/JP05/03485, filed on Mar. 2, 2005.

(30) Foreign Application Priority Data
Mar. 3, 2004 (JP) 2004-059743
Mar. 24, 2004 (JP) 2004-087007

(51) Int. Cl. C09K 19/00

(52) U.S. Cl. 428/1.1; 428/1.26; 428/1.5

(57) ABSTRACT

A novel organic insulating film, which is continuously manufactured and has specific properties over the entire width an adhesive film, a flexible metal plated stacked board, a multiplayer flexible metal-plated stacked board, a coverlay film, a tape for TAB, a base tape for COF are provided. The continuously manufactured organic insulating film satisfies the following requirements (1)-(3) over the entire width; (1) a film MOR-c value is 1.05 or more but not more than 5.0, (2) a molecular chain main axis orientation angle is −30 to 30 degree against MD direction, and (3) a difference between the maximum and the minimum values of the film MOR-c is 1.0 or below.

### BACKGROUND OF THE INVENTION

1. Field of the Invention

The present invention relates to organic insulating films which are produced by continuous processes and have uniform molecular orientations in the MD direction (the longitudinal direction) and the TD direction (the film width direction) of the film across the entire width and to adhesive films, flexible metal-clad laminates, multilayer flexible metal-clad laminates, coverlay films, TAB tapes, and COF base tapes incorporating the organic insulating films.

2. Description of the Related Art

Organic insulating films have been used in industrial applications. Among the organic insulating films, polyimide films, which have high heat resistance and high electrical insulation, are used as heat-resistant electrical insulating materials in a wide variety of industrial fields. In particular, when polyimide films are used as supports of electric wiring boards onto which metal foils are laminated, solder can be used to couple an electrical component, such as an IC, with a copper foil, thereby realizing miniaturization and weight reduction of the electric wiring. Moreover, an electric wiring board including a support constituted from a polyimide film is foldable and thus a long electric wiring board can be manufactured. Therefore, polyimide films are important materials as supports for electrical insulation. However, diversification of usage of electric wiring boards and increasing density of wiring require the supports for electric insulation to have improved mechanical properties, in-plane isotropy, and dimensional stability.

In the technical field of electronics, there is a continuing demand for higher density mount. Thus, in the technical field of flexible printed circuit boards (hereinafter referred to as “FPCs”), there is a strong demand for higher density mount. In the process of manufacturing the FPCs, steps before and after etching experience large ratios of change in dimensions. In order to realize higher density mount, the ratio of change in dimensions of FPCs and/or the variation in ratio of change in dimensions of FPCs must be reduced during these steps.

The ratio of change in dimensions before and after removing at least part of the metal foil from a flexible metal-clad laminate by etching is normally defined as the ratio of the difference between a particular dimension of the flexible metal-clad laminate before etching and the dimension thereof after etching to the particular dimension before etching. If the ratio of change in dimensions is uniform across the plane of the flexible metal-clad laminate (i.e., if the ratio of change in dimensions is uniform in all directions lying in the plane of the flexible metal-clad laminate), a component mounted on the resulting flexible metal-clad laminate having wiring formed thereon can advantageously couple with the substrate by adjusting the correction coefficient. A film having uniform ratios of change in dimensions in all directions is ideally an isotropic film.

Although various methods for making films having isotropy across the entire width have been investigated, no satisfactory method has been found. In making an FPC using an isotropic film, it is possible to design a film by calculating the changes in dimensions that vary anisotropically. A film need not be isotropic across the entire width but should have uniform physical properties across the entire width. A film having molecules oriented in the MD direction across the entire width is also considered useful. However, no film that is produced by a continuous process and satisfies the following properties across the entire film width has been available:

(1) the MOR-c is 1.05 to 5.0;

(2) the orientation angle of molecular chain main axis is −30 to 30 degrees with respect to the MD direction; and

(3) the difference between the maximum and the minimum of the MOR-c of the film is 1.0 or less.

On the other hand, an attempt has been made to improve the dimensional stability of FPCs by adjusting the ratio between the linear expansion coefficient in the machining direction (MD direction) of the polyimide film and the linear expansion coefficient in a direction (TD direction) orthogonal to the machining direction of the polyimide film (Japanese Unexamined Patent Application Publication No. 9-199830). In order to adjust the ratio of the linear expansion coefficients of the film to a particular level, the film is stretched in the MD and TD directions. However, the publication only discloses stretching of a self-supporting polyamic acid film while fixing the both ends of the film and is thus silent as to a film produced by a continuous film making process and uniformly oriented in the longitudinal direction across the entire width.

A representative method for making an FPC includes bonding a metal foil onto a surface of a substrate, which is a flexible organic insulating film, using an adhesive material selected from various adhesives, by heating and press-bonding. In this method, the insulating film is preferably a polyimide film or the like. The adhesive material is typically a thermosetting adhesive, such as an epoxy or acrylic adhesive. Hereinafter, an FPC made using a thermosetting adhesive is also referred to as “three-layer FPC”.

Thermosetting adhesives are advantageous in that they realize bonding at relatively low temperatures. However, since the demands for higher properties, such as heat resistance, flexibility, and electrical reliability, are increasing, the three-layer FPC using the thermosetting adhesive may not be able to meet these stringent requirements. To overcome this difficulty, an FPC that includes a metal layer directly disposed on an insulating film or that uses a thermoplastic polyimide in the bonding layer (hereinafter this FPC is also referred to as “two-layer FPC”) has been proposed. The two-layer FPCs have more desirable properties than the three-layer FPCs and the demands for two-layer FPCs are expected to grow in the future.

Examples of the method for making the flexible metal-clad laminate used in a two-layer FPC include a cast method in which a polyamic acid, i.e., the precursor of the polyimide, is flow-cast or applied on a metal foil, a metallizing method in which a metal layer is directly formed on a polyimide film by sputtering and plating, and a lamination method in which a polyimide film is bonded to a metal foil using a thermoplastic polyimide. Among these methods, the lamination method is superior to the others in that the range of the thickness of the metal foils usable in this method is wider than that in the cast method and that the equipment cost is lower than that of the metallizing method. Examples of the equipment for the lamination include a hot roll laminator and a double belt press machine that can continuously conduct lamination while unreeling a material wound into a roll. Of these, the hot roll laminator is preferable from the standpoint of productivity.

According to a conventional process for preparing a three-layer FPC by the lamination method, a thermosetting resin has been used to form the adhesive layer. Thus, lamination at less than 200° C. has been possible (refer to Japanese Unexamined Patent Application Publication No. 2000-309051 0008). In contrast, since the two-layer FPC uses a thermoplastic polyimide in the adhesive layer, a high temperature of at least 200° C. and sometimes near 400° C. must be applied in order to yield thermal bondability. Thus, a flexible metal-clad laminate produced by the lamination suffers from residual strain, which causes changes in dimensions when wiring is formed by etching or when solder reflow is conducted to mount a component.

For example, in a lamination method, a polyamic acid, which is a precursor of the thermoplastic polyimide, is flow-cast or applied, and continuously heated to perform imidization in order to form a thermoplastic polyimide-containing adhesive layer on a polyimide film, and then a metal foil is bonded thereon. Since heat and pressure are continuously applied not only in the step of imidization but also in the step of bonding the metal layer, the material is frequently placed in a high-temperature environment with a tension applied on the material. The tension is released in the step of etching the metal foil from the flexible laminate and in the step of heating through solder reflow; therefore, the dimensions frequently change before and after these steps.

Ever increasing demands for miniaturization and weight reduction of electronic components have also promoted development of finer wiring to be formed on a substrate. Components mounted on the substrate are also required to achieve miniaturization and higher density. If the change in dimensions after such fine wiring is formed is large, the position of the component mounted may deviate from the position originally designed, thereby generating problem such as defective coupling between the components and the substrate. Thus, various attempts have been made to suppress the change in dimensions by controlling the lamination pressure, by controlling the tension applied to the adhesive film, or the like (refer to Japanese Unexamined Patent Application Publication Nos. 2002-326308 and 2002-326280). Although the techniques disclosed in these publications improve dimensional changes, the degree of improvement is not sufficient. A further improvement on dimensional changes is desired.

### SUMMARY OF THE INVENTION

The present invention provides a novel organic insulating film that has a particular physical property across the entire width of the film and that can be produced by a continuous process. In particular, the present invention provides a polyimide film that can be used in manufacturing flexible copper-clad laminates (FCCLs) and flexible printed circuit boards (FPCS) that undergo small dimensional changes and small ratios of change in dimensions in all directions (e.g., the MD direction, the TD direction, and 45° directions) across the entire width of the film, the film being made by a continuous process. An adhesive film, a flexible metal-clad laminate, a multilayer flexible metal-clad laminate, a coverlay film, a TAB tape, and a COF base tape each incorporating the polyimide film of present invention are also provided. Furthermore, a method for making the adhesive film and a method for making a flexible metal-clad laminate are also provided.

A first aspect of the present invention provide an organic insulating film produced by a continuous process, the organic insulating film satisfying the following requirements (1) to (3) across the entire width of the film:

(1) MOR-c of the film is 1.05 to 5.0

(2) the orientation angle of a molecular chain main axis is −30 to 30 degrees with respect to a MD direction; and

(3) the difference between the maximum MOR-c and the minimum MOR-c of the film is 1.0 or less.

Preferably, the organic insulating film is a polyimide film and, more preferably, contains a polyimide resin having at least one repeating unit selected from those represented by general formulae (1) and/or (2): 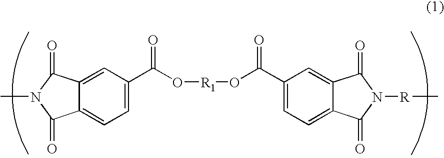
wherein R₁ represents a divalent organic group selected from the group consisting of: 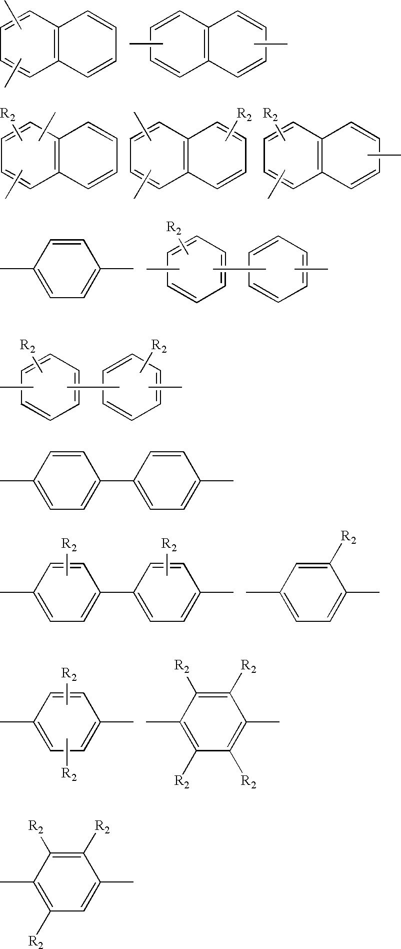
(wherein R²s each represent —CH₃, —Cl, —Br, —F, or —OCH₃), and R represents a divalent organic group represented by 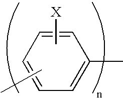
(wherein n represents an integer between 1 to 3; X represents a monovalent substituent selected from the group consisting of hydrogen, halogen, a carboxyl group, a lower alkyl group having 6 or less carbon atoms, and a lower alkoxyl group having 6 or less carbon atoms) and/or 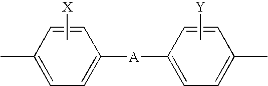
(wherein X and Y each represent a monovalent substituent selected from the group consisting of hydrogen, halogen, a carboxyl group, a lower alkyl group having 6 or less carbon atoms, and a lower alkoxyl group having 6 or less carbon atoms; and A represents a divalent bonding group selected from the group consisting of —O—, —S—, —CO—, SO₂—, and —CH₂—); and 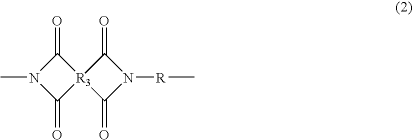
(wherein R is the same as above and R³ represents a tetravalent organic group selected from the group consisting of the following:

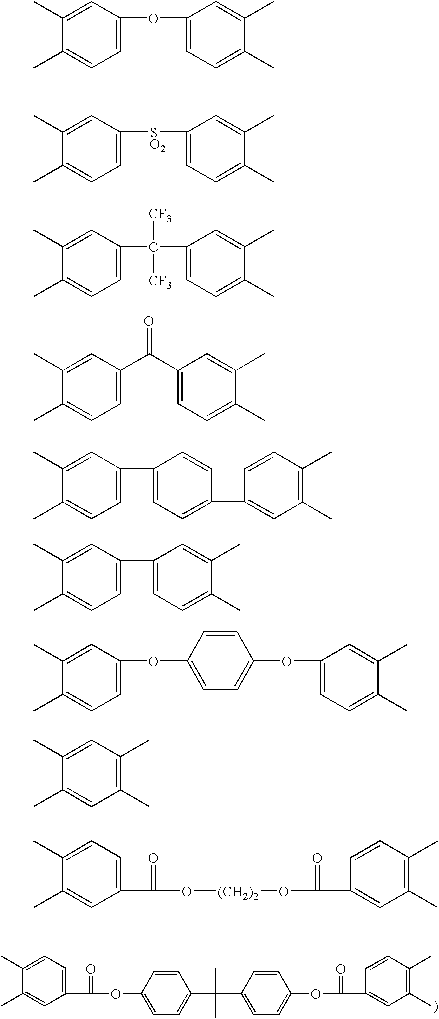

Preferably, the organic insulating film is produced by the steps (A) to (C):

(A) continuously flow-casting and applying a composition containing a polymer and an organic solvent onto a support to prepare a gel film;

(B) peeling the gel film from the support and fixing the both ends of the gel film; and

(C) transferring the film through a heating furnace while fixing the ends of the film.

Preferably, the organic insulating film used in these steps is a polyimide film, and the polymer used in the step (A) is a polyamic acid.

The organic insulating film produced by the continuous process may have a width of 500 mm or more.

A second aspect of the present invention provide a flexible metal-clad laminate including the organic insulating film described above.

A third aspect of the present invention provides a coverlay film including the organic insulating film described above.

A fourth aspect of the present invention provides a TAB tape including the organic insulating film described above.

A fifth aspect of the present invention provides a COF base tape including the organic insulating film described above.

A sixth aspect of the present invention provides a multilayer flexible wiring board including the organic insulating film described above.

A seventh aspect of the present invention provides an adhesive film including the polyimide film described above and an adhesive layer containing a thermoplastic polyimide and being disposed on at least one surface of the polyimide film. The polyimide film is produced by a continuous process.

The adhesive film of the seventh aspect of the present invention may be a long film having a width of 250 mm or more.

The adhesive film may be bonded with a metal foil by a continuous process of heating and pressuring using one or more pairs of metal rollers.

An eighth aspect of the present invention provides a flexible metal-clad laminate obtained by bonding a metal foil onto the adhesive film of the seventh aspect of the present invention.

A ninth aspect of the present, invention provides a method for making an adhesive film constituted from a polyimide film and an adhesive layer containing a thermoplastic polyimide and being disposed on at least one surface of the polyimide film, the method including making the adhesive film by a continuous process using any of the polyimide films described above.

A tenth aspect of the present invention provides a method for making a flexible metal-clad laminate, including a step of bonding a metal foil onto the adhesive film described above by a continuous process under heat and pressure.

Preferably, the temperature for the bonding step above is 200° C. or more and at least 50° C. higher than the glass transition point of the thermoplastic polyimide.

According to the present invention, the physical properties of the film are uniform in the film width direction. By using the film of present invention, it becomes possible to suppress dimensional changes (dimensional changes before and after etching) that would occur during the process of manufacturing FCCLs and FPCs.

Further present invention provides an adhesive film that is used for preparing a flexible metal-clad laminate whose dimensional change is suppressed by a lamination technique in which a film and a metal foil are bonded while applying heat and pressure and a flexible metal-clad laminate prepared by bonding a metal foil onto the adhesive film. In detail, present invention also provides an adhesive film that has a property of fine stability with respect to the ratio of change in dimension across the entire width in case of laminating with it's width of 250 mm or more by a continuous process, a flexible-metal clad laminate prepared from the adhesive film, and methods for producing those films and laminates.

### BRIEF DESCRIPTION OF THE DRAWINGS

FIG. 1 is a diagram for explaining the definition of the molecular orientation angle θ;

FIG. 2 is a diagram illustrating in-plane nonuniformity in film properties caused by a bowing phenomenon;

FIG. 3 shows an example of a hot-blast furnace;

FIG. 4 shows another example of a hot-blast furnace;

FIG. 5 shows an example of a radiant heater furnace;

FIG. 6 shows another example of a radiant heater furnace;

FIG. 7 shows an example of a furnace in which both hot blast and radiant heat rays are simultaneously applied to the film;

FIG. 8 shows another example of a furnace in which both hot blast and radiant heat rays are simultaneously applied to the film;

FIG. 9 shows an example of a method for heating a film without fixing the ends while applying a tension to the film;

FIG. 10 shows an another example of a method for heating a film without fixing the ends while applying a tension to the film;

FIG. 11A illustrates a system for producing a polyimide film;

FIG. 11B is a partial enlarged view of the system shown in FIG. 11A;

FIG. 12 is a schematic diagram for explaining the state in which a film is held between fixing units; and

FIGS. 13A and 13B show sampling methods for determining the degree of orientation and the orientation angle of each of the EXAMPLES and COMPARATIVE EXAMPLES.

FIG. 14 shows the sampling method for determining the dimensional changes.

### REFERENCE SIGN

1 film transferring device

2 first heating furnace

3 second heating furnace

4 third heating furnace

5 slow cooling furnace

6 slow cooling furnace

7 end holding device

8 distance between fixed ends

9 film width between the film transferring device

10 film traveling direction

11 distance between fixed ends

12 distance between fixed ends

13 unit (die) for flow-casting and applying an organic solvent solution

14 support for the organic solvent solution

15 unit for applying tension to the gel film

16 position at which the gel film is stripped off

0101 hot-blast

0102 film traveling direction

0103 film surface

0201 jet nozzle

0202 hot-blast

0203 film traveling direction

0204 film surface

0301 radiant heater

0302 film traveling direction

0303 film surface

0401 radiant heater

0402 radiant heater

0403 film traveling direction

0404 film surface

0501 hot-blast

0502 radiant heater

0503 film traveling direction

0504 film surface

0601 jet nozzle

0602 radiant heater

0603 hot-blast

0604 film traveling direction

0605 film surface

0701 die

0702 belt

0703 fixation of both ends of gel film peeled from a belt

0704 hot-blast furnace

0705 radiant heater furnace

0706 release of fixation of both ends of film

0707 winding into a roll of film after step (B)

0708 unreeling of film after step (B)

0709 hot-blast furnace

0710 radiant heater furnace

0711 winding into a roll of film after step (C)

0801 die

0802 belt

0803 fixing both end of gel film peeled from a belt

0804 hot-blast furnace

0805 radiant heater furnace

0806 release of fixation of both ends of film

0807 hot-blast furnace

0808 radiant heater furnace

0809 winding into a roll of film after step (C)

0901 orientation axis

0902 orientation axis

0903 traveling direction when polyamic acid is flow-cast in a support

1001 MD direction (film transfer direction)

1002 TD direction (film width direction)

### DESCRIPTION OF THE PREFERRED EMBODIMENTS

(Organic Insulating Film of Present Invention)

An organic insulating film of present invention is produced by a continuous process and must be oriented in the MD direction across the entire width of the film. In other words, the organic insulating film of present invention must satisfy the following three requirements across the entire width:

(1) the MOR-c is 1.05 to 5.0;

(2) the orientation angle of molecular chain main axis is −30 to 30 degrees with respect to the MD direction; and

(3) the difference between the maximum and the minimum of the MOR-c of the film is 1.0 or less.

The values in (1) to (3) are measured with a molecular orientation analyzer using a 4 cm square specimen, a described below. For the purposes of explanation, in this invention, the phrase “satisfy the three requirements (1) to (3) across the entire width” means that 4-cm square specimens sampled as below from a film having a particular width and produced by a continuous process satisfy the requirements (1) to (3) at any position.

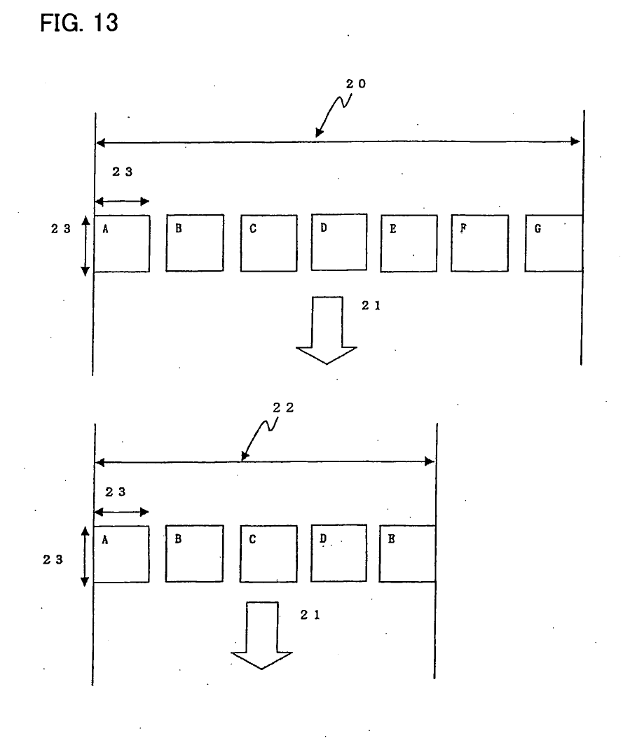

As shown FIG. 13, with respect to a film having a film width of 1,000 mm or more, at least seven specimens are sampled at at least seven equally spaced positions including two positions at the ends. With respect to a film having a film width less than 1,000 mm, at least five specimens are sampled at at least five equally spaced positions including two positions at the ends. This method does not determine the property across the entire width in a strict sense. However, if all specimens sampled as above satisfy the requirements (1) to (3), it is then sufficient to assume that all samples taken across the entire width will also satisfy the requirements (1) to (3) above.

(Measurement of MOR-c)

Indices for the degree of molecular orientation of a film, MOR and MOR-c, will now be described. When specimens in the form of film or sheet are irradiated with microwaves, the intensity of microwaves transmitted through each specimen differs from one specimen to the other depending on the degree of anisotropy of the specimen. The ratio of the long axis to the short axis of polar coordinates (orientation pattern) indicating the differences in transmission intensity is then determined and defined as an MOR value that indicates the state of molecular orientation. The orientation angle and the degree of anisotropy are also identifiable from the orientation pattern described above.

As described above, 4-cm square specimens are taken at equally spaced positions including the both ends, and the direction of transfer is marked on each specimen. The MOR value of each specimen is then determined using a molecular orientation analyzer. For example, the MOR can be determined with a microwave molecular orientation analyzer MOA 2012A produced by KS Systems Inc. By using the analyzer MOA 2012A, the MOR value at one position of a specimen can be measured in a short time, i.e., approximately 2 minutes, and thus the measurement is easy.

The MOR value is in proportion to the thickness. The MOR-c is calculated from the MOR value observed with the analyzer as above according to equation (1) by converting the observed MOR value to the equivalent for a thickness of 75 μm:
MOR-c−(tc/t×(MOR 1))+1 (1)
wherein t is the thickness of a specimen, tc is a reference thickness for conversion, MOR is a value observed by the above-described measurement, and MOR-c is a converted MOR value.

In the equation above, the converted MOR (MOR-c) is calculated by setting to as 75. The closer MOR-c is to 1.000, the more isotropic is the film. Thus, MOR-c serves as a simple index for indicating the in-plane molecular orientation.

The MOR-c value in the MD direction of the film is preferably 1.05 to 5.0.

(Molecular Orientation Angle of Film)

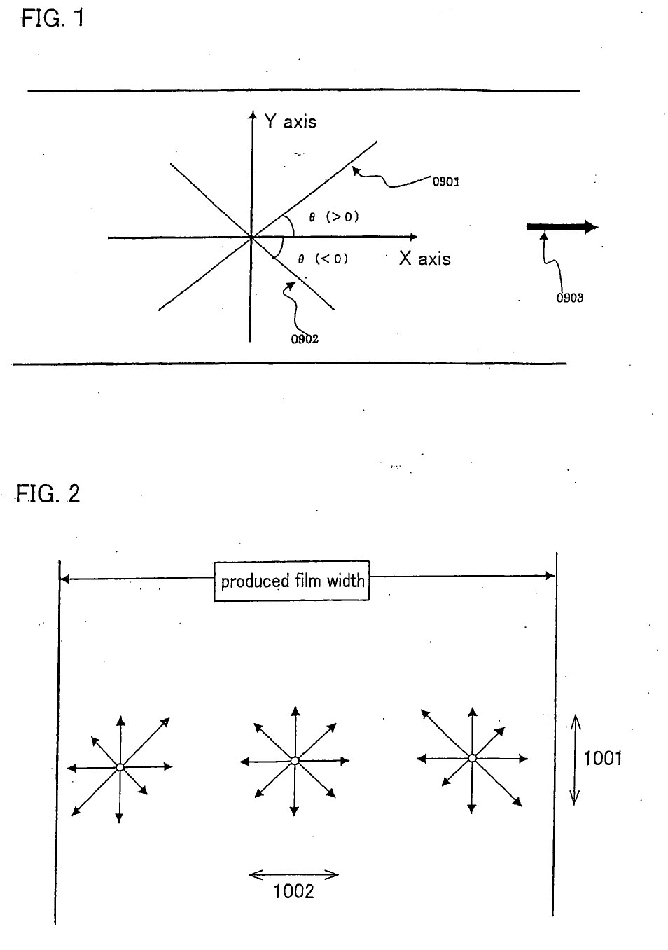

The definition of the molecular orientation angle θ is as follows. A specimen taken as above is analyzed with MOA2012 to determine the direction of molecular orientation in the plane of the film (the maximum orientation at ε′, wherein ε′ is the dielectric constant of the specimen) and this direction can be identified in terms of degrees. In this invention, the line indicating the orientation direction is defined as the “orientation axis” of that specimen. As shown in FIG. 1, the x axis is taken in the longitudinal direction (MD direction) at the film center, and the direction in which the polyamic acid travels when the polyamic acid is flow-cast on a support is defined as the positive direction. Here, the angle defined by the x axis in the position direction and the orientation axis analyzed as above is defined as θ. When the orientation axis lies in the first and third quadrants, the orientation axis organic is defined as positive (0°<θ≦90°). When the orientation axis lies in the second and fourth quadrants, the orientation axis angle is defined as negative (−90°≦0<0°).

The orientation angle of the main axis of the molecular chain is −30° to 30°, preferably −20° to 20°, and more preferably −15° to 15° with respect to the MD direction.

(Difference Between Maximum and Minimum MOR-c's of Film)

The difference between the maximum and the minimum MOR-c's of the film across the entire film width is preferably 1.0 or less, more preferably 0,8 or less, and most preferably 0.6 or less.

(Physical Properties of Organic Insulating Film)

When a film satisfying the requirements (1) to (3) above are used in manufacturing flexible copper-clad laminates (FCCLs) by a continuous process. FCCLs having excellent dimensional stability across the entire width of the films can be obtained and the film can be highly effectively used. The reason for such excellent dimensional stability of the film satisfying the requirements (1) to (3) is possibly related to problems of dimensional changes before and after etching of the FCCLs. The inventors conceive that the following problems of dimensional changes occur before and after etching of the FCCLs.

The dimensional changes of FCCLs before and after etching occur because of nonuniformity in film properties in the width direction. In detail, the properties of the film that affect the dimensional changes of the FCCL are elasticity modulus, linear expansion coefficient, and thermal shrinkage, and in particular, elasticity modulus and linear expansion coefficient. A polyimide film having a relatively large width, e.g., 1,000 mm or more, has uniform properties in all in-plane directions of the film near the center of the film. However, the properties are not uniform in all in-plane directions of the film near the ends of the film (an example is illustrated in FIG. 2). In particular, nonuniformity is particularly noticeable in oblique directions. As a result, although the dimensional changes before and after etching of the FCCL may be small in the MD/TD directions across the film width, the dimensional changes in oblique directions largely differ depending on the positions in the film in the film width direction.

In manufacturing a FCCL, the ratio of change in dimensions before and after removal of at least part of the metal foil by etching is typically indicated in terms of a ratio of the difference between a particular dimension of the flexible metal-clad laminate before etching and the dimension thereof after etching to the particular dimension before etching.

If the ratio of change in dimensions is uniform across the plane of the flexible metal-clad laminate, it becomes possible to secure satisfactory coupling between a substrate, i.e., a flexible metal-clad laminate having wiring, and a component mounted thereon by adjusting the correction coefficient.

If the variation of the ratio of change in dimensions is outside a particular range, the dimensions of the flexible metal-clad laminate greatly change particularly after fine wiring is formed. As a result, the component mount position may deviate from the designed position, and the component mounted on the substrate may not satisfactorily couple with the substrate. In other words, if the variation in ratio of change in dimensions in the plane of the flexible metal-clad laminate is within a particular range, such changes can be taken into account in the designing by calculating the correction coefficient.

The same advantageous effects can be realized not only with films having uniform ratios of change in dimensions in all directions in the plane of the flexible metal-clad laminate but also with the film of present invention having uniform ratios of change in dimensions in a particular direction. Since the film of present invention satisfies the requirements (1) to (3) above, the correction coefficient can be determined by taking into account the dimensional changes in the MD direction that would occur before and after etching of the FCCL. The preferable range of the dimensional changes after the etching of the FCCL is 0.10 or less. The dimensional changes must be measured in the MD direction, the TD direction, 45° to the right, and 45° to the left. Here, “45° to the right” and “45° to the left” are with respect to the MD direction (0°). The film of present invention has a molecular orientation controlled in the MD direction. Thus, the difference in properties is small at 45° to the right and 45° to the left, and it becomes possible to accurately determine the correction coefficient.

The method for determining the ratio of change in dimensions is not particularly limited. Any known method that can determine the increase or decrease in dimensions that occurs before and after etching of a flexible metal-clad laminate can be employed.

A preferred embodiment of the organic insulating film of present invention is an organic insulating film having a MOR-c value of 1.05 to 3.0, an orientation angle of the main axis of the molecular chain of −25° to 25° with respect to the MD direction, and a difference between the maximum MOR-c and the minimum MOR-c of 0.6 or less. A more preferred embodiment is an organic insulating film having a MOR-c value of 1.05 to 3.0, an orientation angle of the main axis of the molecular chain of −20° to 20° with respect to the MD direction, and a difference between the maximum MOR-c and the minimum MOR-c of 0.40 or less. A yet more preferred embodiment is an organic insulating film having a MOR-c value of 1.05 to 3.0), an orientation angle of the main axis of the molecular chain of −1.5° to 15° with respect to the MD direction, and a difference between the maximum MOR-c and the minimum MOR-c of 0.30 or less.

Another preferable embodiment is an organic insulating film having a MOR-c value of 3.0 to 5.0, an orientation angle of the main axis of the molecular chain of −25° to 25° with respect to the MD direction, and a difference between the maximum MOR-c and the minimum MOR-c of 1.0 or less. A more preferable embodiment is an organic insulating film having a MOR-c value of 3.0 to 5.0, an orientation angle of the main axis of the molecular chain of −20° to 20° with respect to the MD direction, and a difference between the maximum MOR-c and the minimum MOR-c of 0.7 or less. A yet more preferable embodiment is an organic insulating film having a MOR-c of 3.0 to 5.0, an orientation angle of the main axis of the molecular chain of −15° to 15° with respect to the MD direction, and a difference between the maximum MOR-c and the minimum MOR-c of 0.6 or less.

(Production of Film)

One of the possible means for producing a polyimide film that satisfies the requirements:

(1) the MOR-c is 1.05 to 5.0;

(2) the orientation angle of molecular chain main axis is −30 to 30 degrees with respect to the MD direction; and

(3) the difference between the maximum and the minimum of the MOR-c or the film is 1.0 or less,

is to modify the conditions of the film production. An example of the method for making a target polyimide film includes the steps of continuously flow casting or applying a composition containing a polymer and an organic solvent onto a support to form a gel film, peeling off the gel from the support and fixing the both ends of the gel film, and transferring the film through a heating chamber while fixing the both ends of the film. The film may be produced by appropriately selecting these steps or introducing additional steps. Modifiable production conditions and production examples will be described below.

Method 1

A method 1 for making an organic insulating film includes the following steps (A) to (C):

(A) flow-casting or applying a composition containing a polymer and an organic solvent onto a support to form a gel film;
(B) peeling off the gel film from the support and heating the gel film while fixing the both ends of the gel film, and
(C) heating the film with its ends being released after the step (B).
   Step (A)

In the step (A), a composition containing a polymer and an organic solvent is applied by flow-casting onto a support, such as an endless belt or a stainless steel drum to form a self-supporting gel film. Examples of the polymer includes, but area not limited to, polyimides, aromatic polyesters, liquid crystal polymers, polyamides, polyolefins, polyetherimides, polyesteramides, vinyl polymers, polyketones, polyphenylene sulfides, and polyether sulfones. A precursor of the target polymer may also be used. An examples thereof is a polyamic acid, which is a precursor of polyimides.

In the present invention, the “gel film” is a polymeric resin film which is formed by heating and drying an organic solvent solution containing a polymer and an organic solvent and which contains the residual organic solvent and/or a reaction product (hereinafter referred to as “residual components”). In the process of producing the polyimide film, the organic solvent dissolving the polyamic acid solution, and imidization catalyst, a dehydrator, reaction products (water-absorbing components of the dehydrator, water, etc., and the like remain as the residual components in the gel film. The residual component ratio c in the gel film is determined by the equation below:
c=a/b×100 (2)
wherein a (unit: g) is the weight of a completely dried synthetic resin in the gel film and b (unit: g) is the weight of the residual components. The residual component ratio c is preferably 500% or less, more preferably 10% to 300%, and most preferably 20% to 200%. At a residual component ratio exceeding 500%, the variation in residual component weight in the plane relatively increases, and it may become difficult to control the properties of the film to a uniform level.

The weight a of the completely dried synthetic resin and the weight b of the residual components are determined as follows. The weight d of a 100 mm×100 mm gel film is measured. The gel film is dried in an oven at 450° C. for 20 minutes, cooled to room temperature, and weighed. The observed weight is defined as the weight a of the completely dried synthetic resin. The weight b of the residual component is the difference between the weight d of the gel film and the weight a of the completely dried synthetic resin, (b−d−a).

In making the gel film, the temperature, air speed, and air discharge speed for heating and drying the solution on the support are preferably controlled so that the residual component ratio is controlled within the above-described range. For example, a preferable temperature for drying the solution on the support is 200° C. or less and a preferable time for drying is 20 seconds to 30 minutes.

Step (B)

In the stop (B), the gel film obtained in the step (A) is peeled off and heated while fixing the both ends with pins, clips, or the like.

In the step (B), the maximum atmosphere temperature during the heating is preferably 450° C. or less, and more preferably 400° C. or less from the standpoint of obtaining a film having controlled molecular orientation across the entire width. Here, “maximum atmospheric temperature” refers to a temperature near the film traveling inside the radiant heater if the heating is conducted with radiant heat rays, and to a temperature of circulating hot air if the heating is conduced with hot blast air.

The heating process in the step (B) is preferably a hot blast air treatment or a radiant heat ray treatment since the film can be uniformly heated in the transverse direction (the TD direction). The combination of the hot blast air treatment and the radiant heat ray treatment is also preferable since the film can be uniformly heated in the transverse direction (the TD direction). When the hot blast air treatment is employed in the heating process of the step (B), the temperature is preferably 450° C. or less and more preferably 400° C. or less. When the radiant heat ray treatment is employed, the temperature is preferably 430° C. or less, and more preferably 400° C. less.

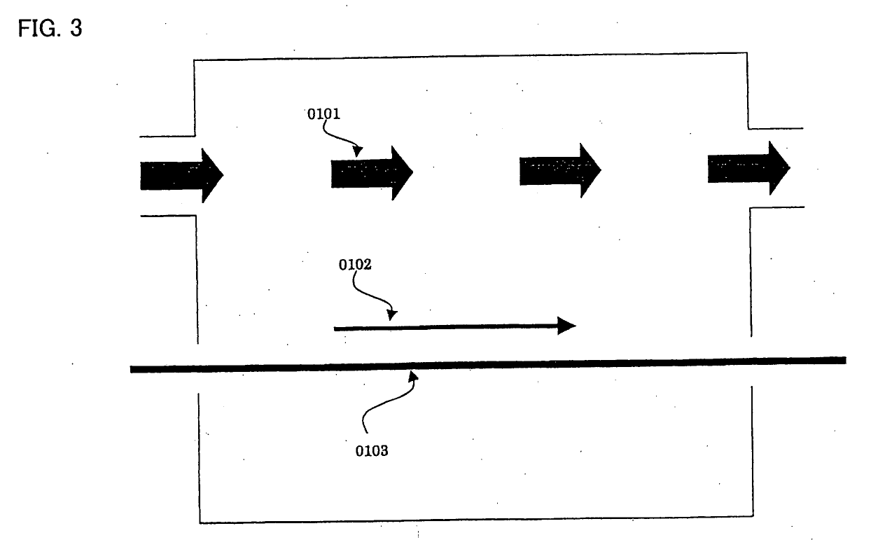

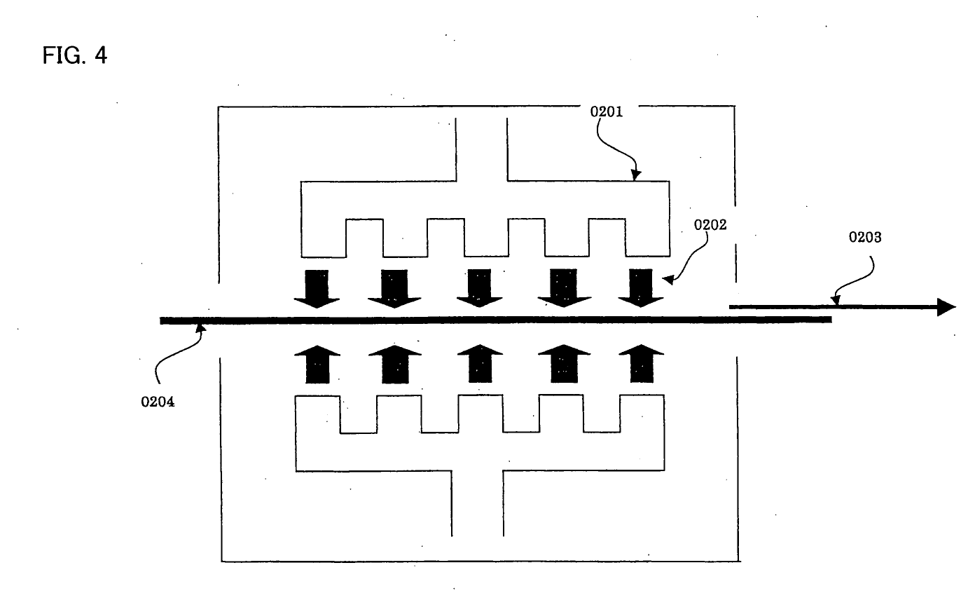

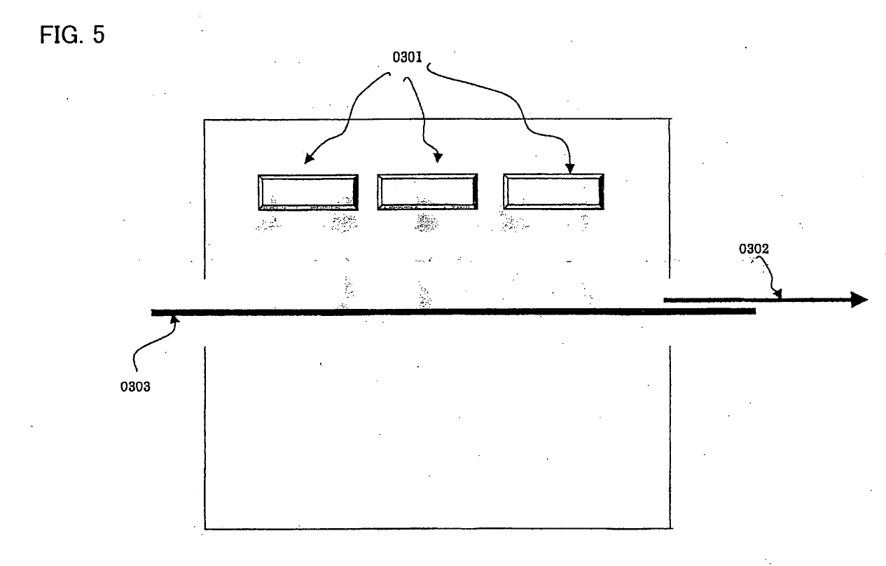

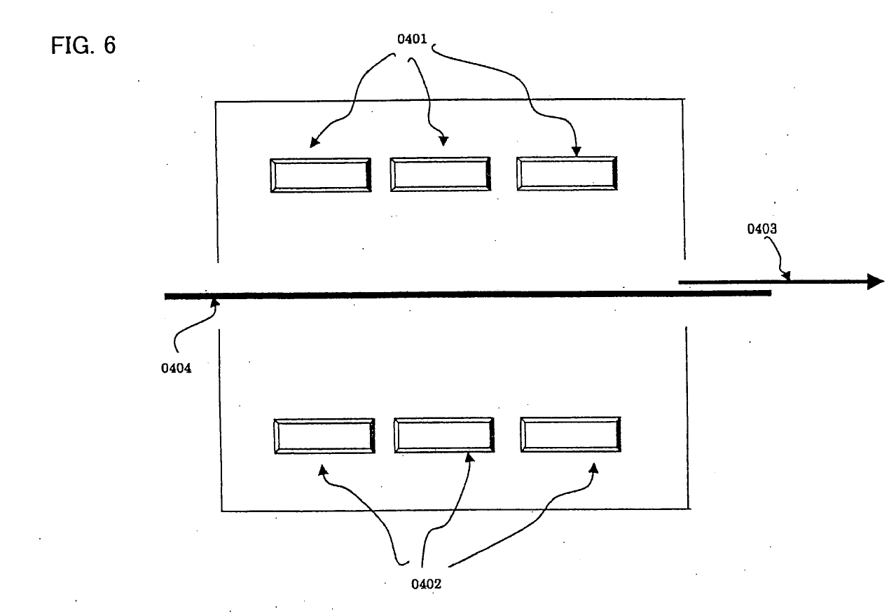

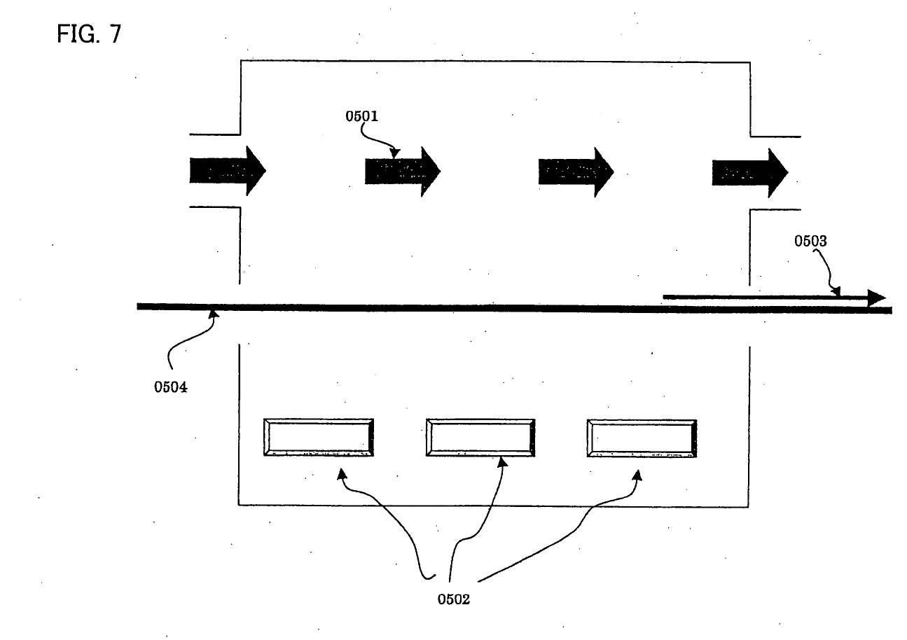

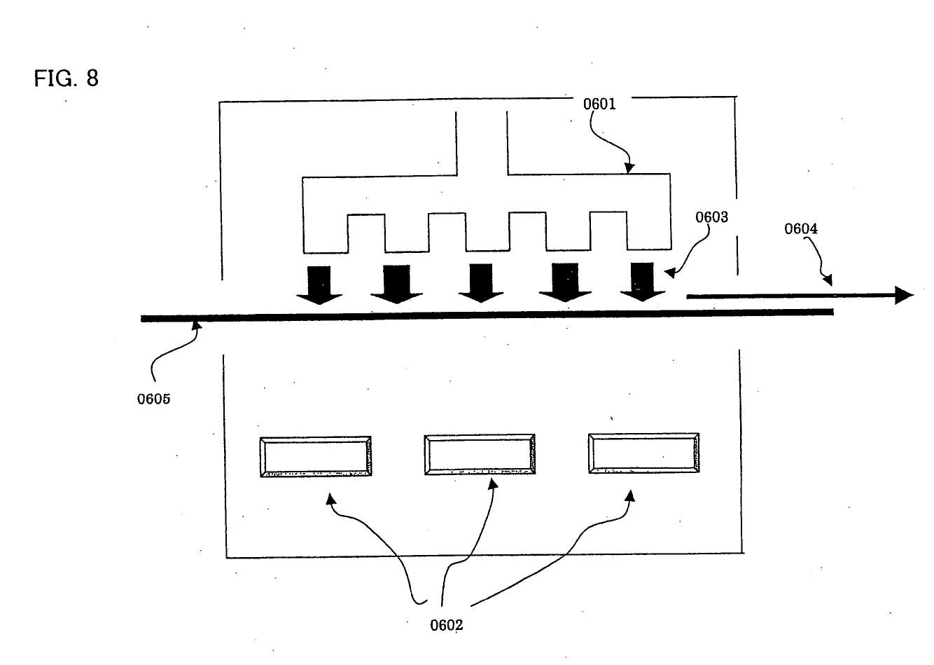

In the hot air treatment, a hot blast furnace may be used to blow hot air to the film. Any hot-blast furnace may be used, but conceivable examples are shown in FIGS. 3 and 4. Also, various methods are possible, for irradiating the film with radiant boat rays. For example, a radiant heater furnace, such as one shown in FIG. 5 or 6, may be used. The radiant rays may be any, and examples thereof include infrared rays and far-infrared rays. Moreover the hot-blast furnaces and the radiant heater furnaces, such as those shown in FIGS. 3 to 6, may be used alone or in combination. Moreover, it is possible to use furnaces shown in FIGS. 7 and 8 to expose the film to both the hot air and the radiant heat rays. From the standpoint of maintaining the molecular orientation of the film uniform in the TD direction, it is preferable to supply hot air and/or radiant heat rays for a width greater than the width of the film in the furnace. For example, the range of supplying the hot air and/or radiant rays is preferably at least 1.05 times the film width. In detail, when hot air treatment is conducted by a jet nozzle technique, the width of the nozzle should be set to at least 1.05 times the film width. When a radiant heater is employed, the width of installing the heater is preferably at least 1.05 times the film width.

In the step (B), the heating temperature is preferably equal to or less than the heating temperature in the step (C) described below from the standpoint of obtaining a film oriented in the MD direction.

As described later, the film of present invention, which is produced in step (B), is in a state before completion of imidization and solvent removal, while in step (C) the imidization proceeds to a sufficient degree and the produced film contains almost no residual solvent. In order to attain the states of the films obtained in steps (B) and (C) as above, it is preferable to employ the heating condition in a manner that the temperature of the step (B) is 20° C. or more lower than the heating temperature of the step (C), which makes the final film oriented in Machine Direction (MD).

Step (C)

In the step (C) subsequent to the step (B), the both ends of the film fixed with the clips, pins, or the like are released, and the film is heated with its ends released. Preferably, the tension of the film in the step (C) is 0.10 to 1.50 kg/mm² in the MD direction. At tension less than 0.10 kg/mm², the molecules of the film may not be oriented in the MD direction. At a tension exceeding 1.50 kg/mm², the flatness of the film may be degraded. The tension is more preferably 0.20 to 1.0 kg/mm² and most preferably 0.20 to 0.80 kg/mm².

In the step (C), the film is preferably heated at a maximum atmospheric temperature of 400° C. or more, and more preferably 430° C. or more, and further preferably at 450° C. or more. At a maximum atmospheric temperature less than 400° C., the molecules are not sufficiently oriented in the MD direction, and a film having molecules oriented in the MD direction across the entire width may not be obtained.

In the step (C), the film is preferably heated by hot air treatment or radiant heat ray treatment since the film can be uniformly heated in the transverse direction (TD direction). The combination of the hot air treatment and the radiant heat ray treatment is also preferable since the film can be uniformly heated in the transverse direction (TD direction).

When the hot air treatment is employed in the heating of the step (C), the temperature of the hot air treatment is preferably 430° C. or more preferably 450° C. to 570° C., and most preferably 470° C. to 560° C. When the maximum atmosphere temperatures is lower than 430° C., the effect of orienting the molecules in the MD direction is not sufficiently achieved, and a film having molecules oriented in the MD direction across the entire width may not be obtained. When the radiant heat ray treatment is employed, the temperature of the treatment is preferably 400° C. or more preferably 430° C. to 570° C., and most preferably 450° C. to 560° C. At a maximum atmospheric temperature lower than 400° C., the effect of orienting the molecules in the MD direction is not sufficiently achieved, and a film having molecules oriented in the MD direction across the entire width may not be obtained.

In the step (C), the hot air treatment and the radiant heat ray treatment may be conducted simultaneously since the film can the uniformly heated in the transverse direction (TD direction). The temperature is preferably 400° C. or more and more preferably 430° C. to 570° C. When the maximum atmospheric temperature is lower than 400° C., the effect of orienting the molecules in the MD direction is not sufficient, and a film having molecules oriented in the MD direction across the entire width may not be obtained.

Examples of the hot-blast furnace for the hot air treatment and the radiant heater furnace for the radiant heat ray treatment usable in the step (C) are the same as those described for the step (B).

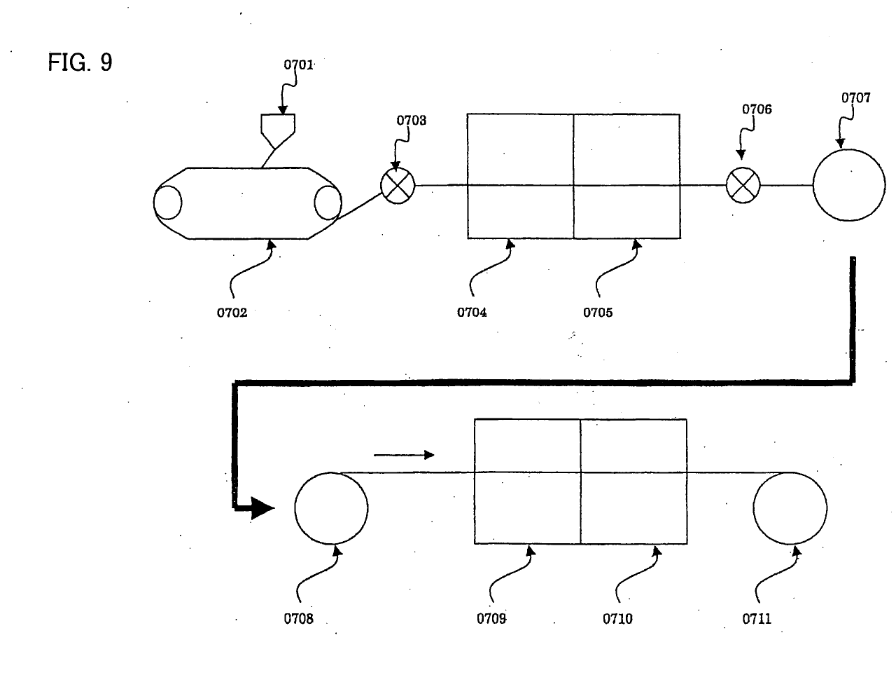

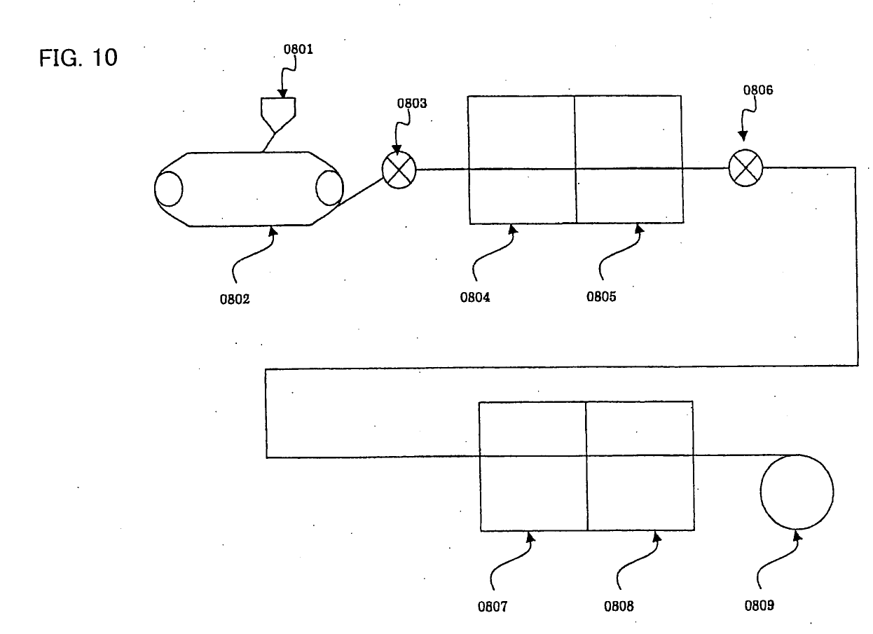

After the film ends are released, the film subjected to the step (B) may be wound into a roll, and then be sent to the step (C), as shown in FIG. 9. For example, the film subjected to the step (B) may be wound into a roll and then transferred through a furnace, such as a hot-blast furnace or a radiant heater furnace, having a roll-to-roll transfer system for the film that can control the tension to perform the step (C). Alternatively, as shown in FIG. 10, the step (C) may be conducted by transferring the film without fixing the ends with pins or the like through a heating furnace, such as hot-blast furnace or radiant heater furnace, after the step (D).

In the step (C), the heating temperature is preferably equal to or higher than the heating temperature in the step (B) to obtain a film oriented in the MD direction.

The present inventors have also found that the heating conditions in the step (B) and the step (C) should be controlled to obtain a film oriented in the MD direction. In the present invention, the film obtained in the step (B) is different from a polyimide film after baking obtained by the method disclosed in Japanese Unexamined Patent Application Publication No. 2000-309501 0008. In detail, whereas the polyimide film after baking is completely imidized and free of residual solvent, the film obtained in the step (B) is in a state before complete imidization and complete solvent removal. Thus, the state of the film obtained in the step (B) is difficult to categorically describe in terms of imidization ratio, residual component ratio the like. The present inventors have found that such a state of the film can be described in terms of the thickness of the film and that the heating conditions (temperature, tension, and retention time) in each step should be controlled to satisfy the relationship T_{b}>T_{c} wherein T_{b} is the thickness of the film obtained in the step (B) and T_{c} is the thickness of the film obtained in the step (C).

The thickness of the film is measured at ten equally spaced points in the TD direction, and the average thickness is determined for each of the step (B) and the step (C), thereby defining the thickness T_{b} and the thickness T_{c}.

Production Example of Polyimide Film

A specific method for making a polyimide film will now be described. First, a method for making a polyamic acid, which is a polyimide precursor, used in step (A) is described. Any known method for making polyamic acid may be used. Typically, substantially equimolar amounts of at least one aromatic acid dianhydride and at least one diamine compound are dissolved in an organic solvent, and the resulting organic solvent solution is agitated under controlled temperature conditions until the polymerization of the aromatic dianhydride and the diamine compound are completed. The concentration of the organic solvent solution is typically 5 to 35 wt % and preferably 10 to 30 wt %. When the concentration is within these ranges, the molecular weight and the viscosity of the solution are adequate.

Any polymerization method may be used. Preferable examples of the polymerization method are as follows:

1) a method of dissolving a diamine compound in an organic polar solvent and reacting the diamine compound with a substantially equimolar aromatic tetracarboxylic dianhydride to conduct polymerization;

2) a method of reacting an aromatic tetracarboxylic dianhydride with less than equimolar of a diamine compound in an organic polar solvent to prepare a prepolymer having acid anhydride groups at both termini and introducing a diamine compound so that the total of the aromatic tetracarboxylic dianhydride and the total of the diamine compound are substantially equimolar;

3) a method of reacting an aromatic tetracarboxylic dianhydride and excess moles of a diamine compound in an organic polar solvent to prepare a prepolymer having amino groups at both termini, introducing an additional diamine compound, and introducing an aromatic tetracarboxylic dianhydride so that the total of the aromatic tetracarboxylic acid dianhydride and the total of the diamine compound are substantially equimolar to conduct polymerization;

4) a method of dissolving and/or dispersing an aromatic tetracarboxylic dianhydride in an organic polar solvent, and introducing a substantially equimolar diamine compound to conduct polymerization; and

5) a method of reaching an equimolar mixture of an aromatic tetracarboxylic dianhydride and a diamine compound in an organic polar solvent.

Examples of the diamine compound include, but are not limited to, aromatic, aliphatic, and alicyclic diamines such as 4,4′-diaminodiphenylpropane, 4,4′-diaminodiphenylmethane, benzidine, 3,3-dichlorobenzidine, 4,4′-diaminodiphenylsulfide, 3,3′-diaminodiphenylsulfone, 4,4′-diaminodiphenylsulfone, 4,4′-oxydianiline(4,4′-diaminodiphenyl ether), 3,3′-oxydianiline(3,3′-diaminodiphenyl ether), 3,4′-oxydianiline(3,4′-diaminodiphenyl ether), 1,5-diaminonaphthalene, 4,4′-diaminodiphenyldiethylsilane, 4,4′-diaminodiphenylsilane, 4,4′-diaminodiphenylethyl phosphine oxide, 4,4′-diaminodiphenyl N-methylamine, 4,4′-diaminodiphenyl N-phenylamine, 1,4-diaminobenzene(p-phenylenediamine), 1,3-diaminobenzene(m-phenylenediamine), 1,2-diaminobenzene(o-phenylenediamine) and analogues thereof. These may be used alone or in combination at any desired mixing ratio. In particular, p-phenylenediamine and/or 4,4′-diaminodiphenyl ether is preferred as the diamine component. The diamine compound increases the rigidity of the resulting polyimide film and facilitates the control of the molecular orientation.

Examples of the aromatic acid dianhydride include, but are not limited to, 2,3,6,7-naphthalenetetracarboxylic dianhydride, 1,2,5,6-naphthalenetetracarboxylic dianhydride, 2,2′,3,3′-biphenyltetracarboxylic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxylicphenyl)methane dianhydride, bis(3,4-dicarboxylicphenyl)ethane dianhydride, oxydiphthalic dianhydride, bis(3,4-dicarboxylicphenyl) sulfone dianhydride, ethylenebis(trimellitic acid monoester anhydride), bisphenol A bis(trimellitic acid monoester anhydride), and analogues thereof. These may be used alone or in combination at any desired mixing ratio. As the aromatic acid dianhydride component, pyromellitic dianhydride, 3,3′,4,4′-biphenyltetracarboxylic dianhydride, 3,3′,4,4′-benzophenonetetracarboxylic dianhydride, and p-phenylene bis(trimellitic acid monoester anhydride) may be used alone or in combination at any desired mixing ratio. In order to control the molecular orientation axis, the polyimide film preferably contains at least one aromatic acid dianhydride selected from the group consisting of pyromellitic dianhydride, 3,3′,4,4′-biphenyltetracarboxylic dianhydride, 3,3′,4,4′-benzophenonetetracarboxylic dianhydride, and p-phenyl bis(trimellitic acid monoester anhydride) so that the polyimide film has a rigid structure and the molecular orientation is easy to control.

The basic requirements of organic insulating films for use in FCCLs and FPCs are adequate elasticity modulus (2.5 to 12.0 GPa), adequate linear expansion coefficient (1 to 30 ppm/° C.), and low hygroscopic expansion coefficient (15 ppm/RH % or less, 40 to 80 RH %). These properties are selected and adjusted according to adhesives and copper foils used in combination. From the standpoint of flexibility of the FPCs, the elasticity modulus of the organic insulating film is preferably at least 4.0 GPa. From the standpoint of flexibility of FPCs (spring-back property), the elasticity modulus of the organic insulating film is preferably 10.0 GPa or less. The elasticity modulus is determined according to Japanese Industrial Standards (JIS) K7127, Plastics: Test of Tensile Properties. The linear expansion coefficient here is determined by measuring the linear expansion coefficient with a mechanical analyzer, TMA120C produced by Seiko Instruments Inc., under a nitrogen stream at a heating rate of 10° C./min for the temperature range of 23° C. to 400° C. and then averaging the observed values in the temperature range of 100° C. to 200° C.

The thickness of the organic insulating film for use in FCCLs and FPCs across the entire plane is preferably within the ranges below from the standpoints of processability of applying an adhesive and the ratio of change in dimensions during FPC processing, wherein the desired thickness (median) is T μm:

(A) the thickness is in the range of T−T×0.10 to T+T×0.10 [μm] across the entire surface;

(B) in the film flow direction (the MD direction), the maximum thickness−the minimum thickness=T×0.15 or less [μm]; and

(C) n a direction (the TD direction) orthogonal to the film flow direction, the maximum thickness−the minimum thickness'T×0.15 or less [μm].

If the thickness significantly deviates from the ranges (A) to (C), the thickness of the applied adhesive becomes nonuniform, and the properties, in particular, the linear expansion coefficient, of the resulting film may become nonuniform.

In making a FCCL or FPC including a metal layer bonded with an adhesive, it is preferable to use a thermoplastic polyimide adhesive from the standpoint of heat resistance of the FCCL or FPC. From the standpoint of the flexibility of the FPC, the thickness of the applied adhesive is 10 μm or less. From the standpoint of the bondability between the adhesive and the metal foil, the thickness of the applied adhesive is 0.5 μm or more.

A preferable polyimide film that exhibits the properties described above is a polyimide film having a repeating unit represented by general formula (1): 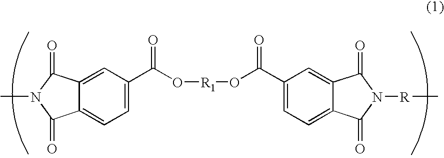
wherein R₁ represents a divalent organic group selected from the group consisting of: 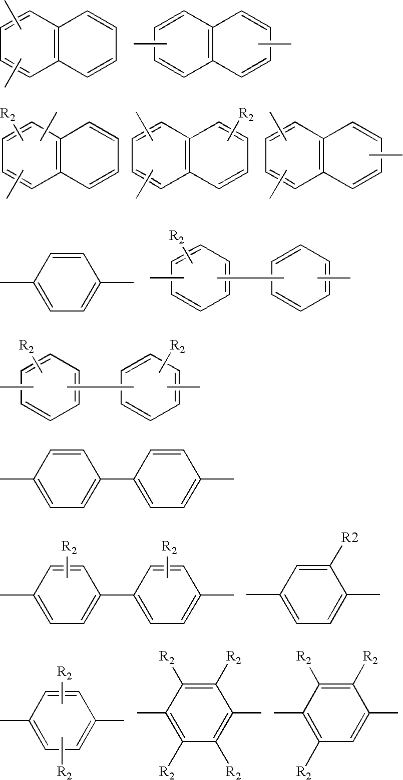
(wherein R²s may be the same or different and each represent —CH₃, —Cl, —Br, F, or —OCH₃), and R represents a divalent organic group represented by 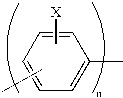
(wherein n represents an integer between 1 to 3; X may be the same or different and represents a monovalent substituent selected from the group consisting of hydrogen, halogen, a carboxyl group, a lower alkyl group having 6 or less carbon atoms, and a lower alkoxyl group having 6 or less carbon atoms) and/or 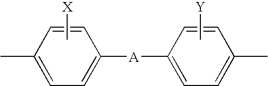
(X and Y may be the same or different and each represent a monovalent substituent selected from the group consisting of hydrogen, halogen, a carboxyl group, a lower alkyl group having 6 or less carbon atoms, and a lower alkoxy group having 6 or less carbon atoms; and A represents a divalent bonding group selected from the group consisting of —O—, —S—, —CO—, SO₂—, and —CH₂—).

A polyimide film having a repeating unit represented by general formula (2) is also preferable: 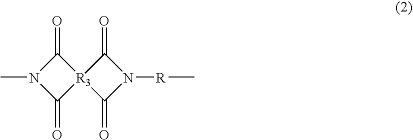
(wherein R is the same as R in general formula (1), and R³ represents a tetravalent organic group selected from the group consisting of:

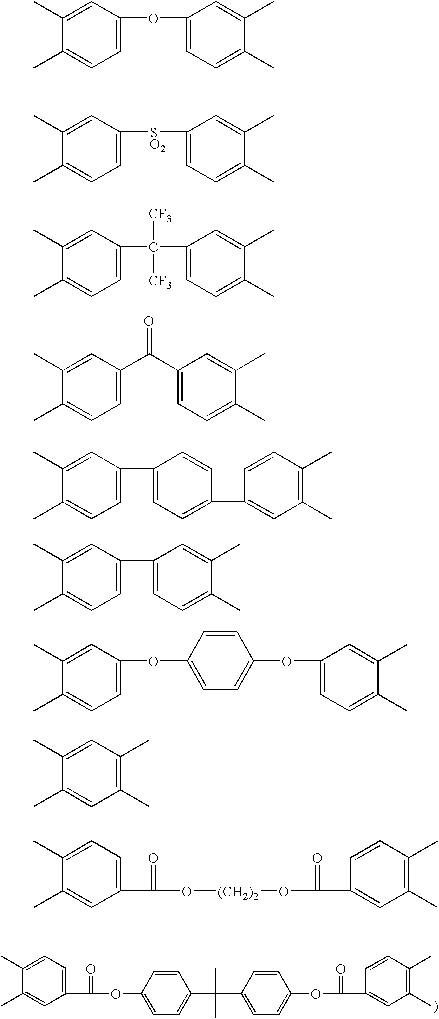

A polyimide film having structures represented by general formula (1) and general formula (2) is preferable for yielding the above-described properties.

Preferable examples of the solvent for synthesizing polyamic acid include amide solvents, such as N,N-dimethylformamide, N,N-dimethylacclamide, and N-methyl-2-pyrrolidone. N,N-Dimethylformamide and N,N-dimethylacetamide are particularly preferable.

A known method may be employed to produce a polyimide film from a polyamic acid solution. The method can be categorized in two: thermal imidization and chemical imidization. In thermal imidization, imidization is progressed solely by heating without using any dehydrator or imidization-catalyst. The heating conditions differ according to the type of polyamic acid used, the thickness of the film, and the like. In chemical imidization, a solution of polyamic acid in an organic solvent is interacted with a dehydrator and an imidization catalyst. Examples of the dehydrator include aliphatic acid anhydrides such as acetic anhydrides and aromatic acid anhydrides such as benzoic anhydrides. Examples of the imidization catalyst include aliphatic tertiary amines such as triethylamine, aromatic tertiary amines such as dimethylaniline, and heterocyclic tertiary amines such as pyridine, picoline, and isoquinoline. Among these, the dehydrator is preferably an acetic anhydride, and the imidization catalyst is preferably isoquinoline. To one mole of amic acid in the polyamic acid organic solvent solution, 1.0 to 4.0, preferably 1.2 to 3.5, and most preferably 1.5 to 2.5 moles of acetic anhyride is added, and, to one mole of amic acid in the polyamic acid organic solvent solution, 0.1 to 2.0, preferably 0.2 to 1.5, more preferably 1.3 to 1.2, and most preferably 0.3 to 1.1 moles of isoquinoline is preferably added to prepare a polyimide film of desired properties. For example, if imidization is conducted in a short time after mixing the polyamic acid, the dehydrator, and the imidization catalyst, the flowability of the solution in the die may be degraded or the film may break during the transfer in the center furnace.

Additives, such as a heat stabilizer, an antioxidant, a UV absorber, an antistatic agent, a flame retarder, a pigment, a dye, a fatty ester, and organic lubricant (such as wax) way be added in typical used amounts within the range that do not impair the effects of the present invention, in order to impart high slidability, wear resistance, and scratch resistance to the film surface, inorganic particles, such as clay, mica, titanium oxide, calcium carbonate, kaolin, talc, wet or dry silica, colloidal silica, calcium phosphate, calcium hydrogen phosphate, barium sulfate, alumina, or zirconia, or organic particles such as acrylate, styrene, or the like may be added. Alternatively, the film may contain internal particles that are deposited due to the catalyst added for preparation of polyestor by polymerization or may contain a surfactant.

A composition containing the polyamic acid solution prepared as above or a composition containing the polymic acid solution, a dehydrator, and an imidization catalyst is flow-cast onto a support, such as an endless belt or stainless steel drum, and dried to form a self supporting gel film. The cast solution is preferably dried on the support at 200° C. or less for 20 seconds to 30 minutes. The support may be any support that does not dissolve in the solution resin and that can withstand the heat required to remove the organic solvent solution in the synthetic resin solution. In particular, an endless belt of a metal drum made by joining metal boards is preferable for drying the applied solution. The endless belt or drum is preferably composed of metal, and more preferably a SUS stainless steel. The surface of the belt or drum is preferably plated with a metal such as chromium, titanium, nickel, cobalt, or the like to enhance the adhesion of the solvent on the surface and to facilitate peeling of the dried organic insulating film. The endless belt or metal drum preferably has flat and smooth surface. However, numerous irregularities may be formed in the surface of the endless belt or metal drum. Here, the irregularities are preferably 0.1 to 100 μm diameter and 0.1 to 100 μm in depth. By forming the irregularities in the metal surface, it becomes possible to form fine projections on the surface of the organic insulating film, and these projections prevent scratches generated by friction between films and increase the slippage between the films.

Next, the film is peeled from the support, and the both ends of the film are fixed with pins and the like, as described above. The film is then heated while being transferred. The ends are subsequently released and the film is heated as described above to obtain a final product film oriented in the MD direction.

Method 2

A method 2 for making an organic, insulating film by a continuous process includes the following steps (A) to (C):

(A) continuously flow-casting or applying a composition containing a polymer and an organic solvent onto a support to form a gel film;

(B) peeling off the gel film from the support and fixing the both ends of the gel film; and

(C) transferring the film through a heating furnace while fixing the both ends of the film.

In at least part of the step (C), the film is transferred with its ends fixed so that the tension in the film width direction (TD direction) is substantially zero. Each step will be described in detail below.

Step (A)

In the step (A), the same process employed in Method 1 described above may be employed to form the gel film. At this stage, the residual component ratio in the gel film is preferably 500% or less, more preferably 25% to 200%, and most preferably 30% to 150%.

In making a polyimide film by the method 2, the elasticity modulus of the film is preferably high to obtain the target film. By improving the elasticity modulus of the polyimide film, contraction stress is generated in the film surface by volumetric shrinkage that occurs during the evaporation of the residual volatile components in the film, thereby promoting the in-plane molecular orientation by the contraction stress. As a result, the molecular orientation of the polyimide film is promoted. From this viewpoint, in the method 2, the film preferably contains at least one acid dianhydride selected from the group consisting of pyromellitic dianhydride, 1,2,3,4-benzenetetracarboxylic dianhydride, 3,3′,4,4′-biphenyltetracarboxylic dianhydride, 2,2′,3,3′-biphenyltetracarboxylic dianhydride, 3,3′,4,4′-benzenephenonetetracarboxylic dianhydride, 2,2′3,3′-benzophenonetetracarboxylic dianhydride, and p-phenylene bis(trimellitic acid monoester anhydride) among the acid dianhydrides described for the method 1 to impart heat resistance to the polyimide film, increase the elasticity modulus of the film, and facilitate the molecular orientation of the polyimide film.

Among the diamine components described in the method 1, at least one selected from the p-phenylenediamine, m-phenylenediamine, 3,3′-diaminodiphenyl ether, 3,4′-diaminodiphenyl ether, 4,4′-diaminodiphenyl ether, 2,2-bis[4-(4-aminophenoxy)phenyl]propane is preferably used to improve the heat resistance of the polyimide film and to impart rigidity to the film. Preferably, p-phenylenediamine and/or 4,4′-diaminodiphenyl ether are used together as the essential components to increase the elasticity modulus of the polyimide film and to facilitate the orientation of the polyimide film.

Examples of the particularly preferable polyimide film are as follows: (1) a polyimide film made from four monomers, i.e., p-phenylene diamine, 4,4′-diaminodiphenyl ether, pyromellitic dianhydride, and p-phenylene bis(trimellitic acid monoester anhydride); (2) a polyimide film made from p-phenylenediamine, 4,4′-diaminodiphenyl ether, pyromellitic dianhydride, and 3,3′,4,4′-biphenyltetracarboxylicdianhydride; (3) a polyimide film prepared from p-phenylenediamine, 4,4′-diaminodiphenyl ether, pyromellitic dianhydride, and 3,3′,4,4′-benzophenonetetracarboxylic dianhydride; (4) a polyimide film made from p-phenylenediamine, 4,4′-diaminodiphenyl ether, pyromellitic dianhydride, p-phenylene bis(trimellitic acid monoester anhydride), and 3,3′,4,4-biphenyltetracarboxylic dianhydride; (5) a polyimide film made from p-phenylenediamine, 4,4′-diaminodiphenyl ether, and 3,3′,4,4′-biphenyltetracarboxylic dianhydride; (6) a polyimide film made from 4,4′-diaminodiphenyl ether, 3,4′-diaminodiphenyl ether, and pyromellitic dianhydride; (7) a polyimide film made from 4,4′-diaminodiphenyl ether, p-phenylenediamine, 2,2-bis[4-(4-aminophenoxy)phenyl]propane, pyromellitic dianhydride, and 3,3′4,4′-benzophenonetetracarboxylic dianhydride; and (8) a polyimide film made from p-phenylenediamine and 3,3′,4,4′-biphenyltetracarboxylic dianhydride. These polyimide films are preferred since control of the molecular orientation angle is easy.

Step (B)

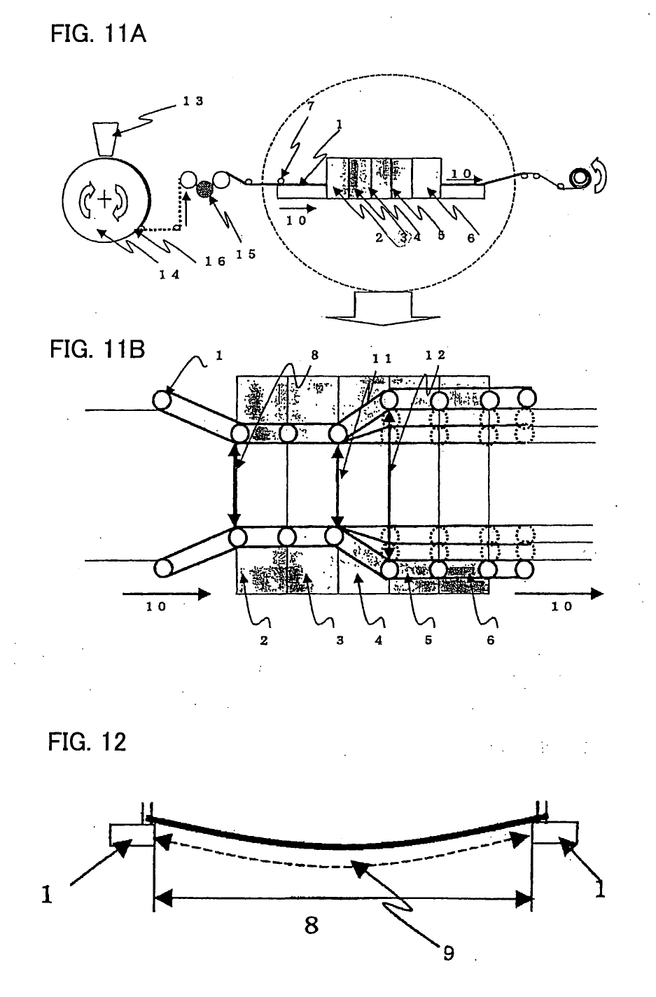

In the step (B), the gel film is peeled from the support and the ends of the gel film are fixed continuously. In the present invention, the step of fixing the ends of the gel film refers to a step of holding ends of a gel film using typical holders used in typical film production systems, such as pin seats and clips. An example of the step of fixing the both ends of the gel film is illustrated in FIGS. 11A and 11B. Referring to FIG. 11A, the step of fixing the both ends of the gel film is conducted at a position 7 where an end holding device (pin seats or clips) installed in a film transfering device 1 begins holding the ends of the film.

In at least part of the subsequent step (C) described below, the film is fixed so that the tension in the TD direction is substantially zero. As the method for fixing the film in such a manner, the film may be fixed in this step (B) so that the tension in the TD direction is substantially zero. In other words, this is a method in which the tension in the TD direction is made substantially zero in the stage of fixing the ends of the film and the film is directly send to the step (C). In particular, the ends of the film are fixed by relaxing the film.

Step (C)

In the step (C), the film is transferred through a heating furnace while having its ends fixed. In this invention, in at least part of the step (C), the film is preferably fixed and transferred so that the tension in the film width direction (TD direction) is substantially zero to obtain a target organic insulating film.

Here, the phrase “the tension in the TD direction is substantially zero” means that no tensile force other than the one from the own weight of the film is applied in the TD direction, i.e., no tensile force caused by mechanical handling is applied. To be more specific, as shown in FIG. 12, a distance 8 between fixing units for fixing the both ends of the film is smaller than a width 9 of the film between the fixing units. A film held in such a state is referred to as a film to which substantially no tension is applied. Explaining with FIG. 2, the film is fixed by fixation device. In this case, length of 8 in FIG. 2 is a distance of fixing units for fixing the both ends. Typically, tension is applied to the both ends of the film so that the film is tightly stretched between the fixing units. In such a state, the distance 8 between the fixing units and the width 9 of the film between the fixing units are the same. In this invention, as shown in FIG. 12, the distance 8 differs from the width 9. The distance 8 is smaller than the width 9. In other words, the film is fixed by relaxing the film. From the standpoint of control of molecular orientation in the MD direction, the distance 8 and the width 9 preferably satisfy the relationship:
20.0≧(Y−X)/Y×100>0.00 (2)
wherein X represents the distance 8 between the fixing units and Y represents the width 9 of the film between the fixing units. When (Y−X)/Y×100 (hereinafter also referred to as “TD contraction ratio”) is increased beyond the above-described range, it becomes difficult to stably control the relaxing of the film, and the amount of relaxation may vary relative to the direction of the transfer. In some cases, the film may drop from the fixing units due to relaxing, and stable film production may not be ensured. More preferably, the relationship 15.0≧(Y−X)/Y×100>0.00 is satisfied, and most preferably the relationship 10.0≧Y−X)/Y×100>0.00 is satisfied.

In this invention the film is preferably fixed so that substantially no tension is applied in TD direction at the entry of the furnace in the step (C) from the standpoint of producing a film having an orientation axis in the MD direction over the entire film width. In order to transfer the fixed film so that substantially no tension is applied in the TD direction at the entry of furnace, the film is preferably fixed in the process of fixing the ends of the gel film in the step (B) so that substantially no tension is applied in the TD direction and then directly sent to the step (C) (first method). Alternatively, as shown in FIG. 11B, after the step (B), the distance between the fixing unit may be decreased once before the film is sent to the step (C) (second method). In the (first method), the relationship (2) is preferably satisfied in fixing the both ends of the gel film. In the (second method), the relationship (2) is preferably satisfied in decreasing the distance between the fixing units.

After completion of the (first method) or the (second method), the distance between the fixing units may again decreased after entering the furnace in the step (C) (third method). In the (third method), it is preferable to decrease the distance between the fixing units in the temperature range of 300° C. or less; preferably 250° C. or less, most preferably 200° C. or less. When the operation of the (third method) is conducted at temperatures higher than 300° C., the orientation of the film tends to become difficult to control. In particular, the orientation at the ends of the film becomes difficult to control.

As is described above, in this invention, it is essential that the gel film experience the state in which substantially no tension is applied in the TD direction immediately before the gel film is heated.

In the step (C), the film is further dried and imidization proceeds. Thus, the film undergoes some shrinking. When the tension in the TD direction is substantially zero to the entry of the furnace during the transfer of the fixed film, thermal shrinkage of the film decreases the film width. As a result, the distance between the fixing units becomes the same as the width of the film between the fixing units, and a wrinkle-free film is produced thereby.

In this invention, in the step (C), a substep (C-2) of stretching the film in the TD direction may be included.

The substep (C-2) of stretching the film in the TD direction is conducted after the substep (C-1) of fixing the film so that the tension in the film width direction (TD direction) is substantially zero and transferring the film. The film heated in the furnace undergoes some shrinkage, and the film is no longer relaxed. The film is then stretched in the TD direction. Referring to FIG. 11B, the amount of stretching (hereinafter also referred to as “degree of expansion”) preferably satisfies the relationship below:
40.0≧(W−Z)/Z×100>0.00) (4)
wherein Z represents the distance (denoted by reference numeral 11) between the fixing units in the TD direction before the stretching and W represents the distance (denoted by reference numeral 12) between the fixing units in the TD direction after the film is stretched in the TD direction in the furnace. When (W−Z)/Z×100 (sometimes referred to as “TD expansion ratio”) is beyond the above described range, it may become difficult to control the molecular orientation axis of the film in the MD direction. More preferably, the relationship 30.0≧(W−Z)/Z×100>0.00 is satisfied, and most preferably the relationship 20.0>(W−Z)/X×100>0.00 is satisfied.

In the substep (C-2), the film may be stretched in the TD direction by gradually increasing the distance between the fixing units. If necessary, contraction may again be performed or the film width may be increased after the substep (C-2). The amounts of contraction and expansion are preferably adequately selected.

The temperature for conducting the substep (C-2) is preferably 300° C. to 500° C. for a polyimide film having high heat resistance. In particular, the temperature is in the range of 350° C. to 480° C. so that the elasticity modulus of the polyimide film is low and the film is easy to stretch. In the above-described temperature range, the film may soften and may be excessively stretched. In such a case, the temperature range other than ones above is preferably selected.

In the substep (C-2), the TD expansion ratio can be adjusted to decrease the degree of orientation of the film oriented in the MD direction. In other words, by stretching the film in the substep (C-2), the degree of orientation of the film can be freely controlled.

In the present invention, a polyimide film having molecules oriented in the MD direction can be made by adequately adjusting the contraction in the substep (C-1), the stretching in the substep (C-2), the film tension in the MD direction while the film is being transferred, the weight of the residual components in the gel film, and the heating temperature. When the organic insulating film is a polyimide film, the heating temperature and heating times drastically differ depending on whether chemical imidization or thermal imidization is conducted. However, the target film can be obtained by controlling the method according to the present invention even when thermal imidization is conducted.

Examples of the preferable furnace for the present invention include a hot-blast furnace in which the film is heated by blowing hot air of 60° C. toward the entire film from both or one of the upper surface and the lower surface of the film and a far-infrared oven equipped with a far-infrared ray generator for baking the film by far infrared radiation. In the heating step for baking the film, it is preferable to increase the temperature stepwise. Thus, it is preferable to use a stepped furnace system including a plurality of hot-air furnaces or far-infrared furnaces or both hot-blast furnaces and far-infrared furnaces connected to one another.

In the baking step described above of the process for producing a polyimide film, the heating temperature first applied to the gel film transferred into the furnace while fixing the ends is preferably 300° C. or less, more preferably 60° C. to 250° C., and most preferably 100° C. to 200° C. In this manner, it is easy to obtain an organic insulating film having molecular orientation controlled in the MD direction. In detail, referring to FIGS. 11A and 11B, the gel preferably transferred through two or more heating furnaces, and the temperature of the first heating furnace (a first heating furnace 2 in FIG. 11) is preferably set to 300° C. or less. Moreover, in order for the system to be suitable for other types of organic insulating films, the temperature is preferably adjusted by taking into consideration the type of the organic insulating film and the volatilization temperature of the solvent. In particular, it is preferable to investigate the boiling point of the solvent contained in the gel film, and the temperature is preferably, controlled to be 100° C. or less higher than the boiling point of the solvent.

In making the polyimide film, when the temperature first applied to the gel film transferred into the furnace is higher than 300° C., a bowing phenomenon occurs and it frequently becomes difficult to control the orientation axes in the ends of the film. Here, “bowing phenomenon” refers to development of higher molecular orientation tendencies at the end portions of the film caused by the film contraction which causes the center portion of the film to be transferred into the furnace ahead of the end portions of the film. In baking the polyimide film, the temperature of the second furnace, (a second heating furnace 3 in FIG. 11) is preferably in the range of first heating furnaces temperature +50° C. to first heating furnace (a first heating furnace 2 in FIG. 11) temperature 1300° C. More preferably, the temperature of the second heating furnace 3 is in the range of first heating furnace temperature 450° C. to first heating furnace temperature +250° C. to control the molecular orientation axis of the polyimide film in the MD direction. The temperatures in the subsequent furnaces are preferably controlled to typical levels for making polyimide films. However, when the temperature of the first heating furnace 2 (a first heating furnace 2 in FIG. 11) is 60° C. or lower, the subsequent furnaces (second heating furnace 3 in FIG. 11) is preferably set to a temperature in the range of 100° C. to 250° C. By setting to the temperature in the second heating furnace 3 when the temperature in the first heating furnace in FIG. 11 60° C. or lower, a polyimide film having controlled molecular orientation axes can be produced. Although the temperatures of the first and second furnaces are preferably set as above, the temperatures for other furnaces are preferably set to typical levels employed for production of polyimide film. For example, the film may be baked stepwise up to a maximum temperature of 600° C. and then be gradually cooled to room temperature. When the maximum baking temperature is low, the imidization may not be complete. Thus, the film must be sufficiently baked.

The tension applied in the MD direction to the gel film transferred into a furnace is calculated in terms of the tension (load) applied per meter of a film. The tension is preferably 1 to 20 kg/m, more preferably 1 to 15 kg/m, and most preferably 1 to 10 kg/m. At a tension of less than 1 kg/m, it becomes difficult to stably transfer the film, and it tends to difficultly produce the film which is stable by be held. At a tension exceeding 20 kg/m, it becomes difficult to control the molecular orientation of the ends of the film in the MD direction particularly and to control the degree of orientation at the ends of the film. Examples of the device for applying tension to the gel film transferred into the furnace and controlling the tension include leading rollers that apply loads to the gel film, rollers that apply variable loads by adjusting the rotating speed, and nip rollers for controlling the tension by clamping the gel film with two rollers.

The tension is preferably adequately adjusted within the above-described range according to the thickness of the polyimide film. The film thickness is preferably 1 to 200 μm and more preferably 1 to 100 μm from the standpoint of molding the polyimide film. At a thickness exceeding 200 μm, the contraction stress generated in the film is increased, and the molecular orientation of the polyimide film may not be controlled in the MD direction by applying the method of the invention.

In this invention, the contraction in the substep (C-1), the stretching in the substep (C-2), the tension in the MD direction applied during the transfer of the film, the residual component ratio of the gel film, and the heating temperature may be adequately adjusted to prepare a film having a molecular orientation controlled in the MD direction. When the organic insulating film is a polyimide film, the heating temperature and time for the film greatly differ depending on whether chemical imidization is performed or thermal imidization is performed. Even when thermal imidization is performed, the target film can still be obtained by controlling according to the method of present invention.

[Applications of Organic Insulating Film of Present Invention]

The organic insulating film of present invention may be used to form an adhesive film by disposing an adhesive layer on at least one surface of the organic insulating film of present invention. Moreover, the organic insulating film of present invention may be used to form a flexible metal-clad laminate, a multilayer flexible metal-clad laminate, a coverlay film, a TAB film, or a COF base tape.

By using the organic insulating film of present invention to produce FCCL and FPCs, dimensional changes that would occur during the production of FCCLs and FPCs can be suppressed. The effects of the invention are particularly noticeable when the film of present invention is used as a substrate onto which a metal foil is bonded by thermal pressing using an adhesive material. The effects are particular significant when the film is applied in making a FPC using an adhesive layer composed of a thermoplastic polyimide.

The adhesive film constituted from an organic insulating film composed of polyimide and an adhesive layer composed of a thermoplastic polyimide will now be described.

(Adhesive Film)

A preferable embodiment of the adhesive film of the present invention is constituted from a polyimide film and a thermoplastic polyimide-containing adhesive layer disposed on at least one surface of the polyimide film and is produced by a continuous process.

(I) Polyimide Film

The polyimide film described in the section, an organic insulating film of present invention, is used as a polyimide film

(II) Adhesive Layer Containing Thermoplastic Polyimide

Preferable examples of the thermoplastic polyimide contained in the adhesive layer of the adhesive film of present invention include thermoplastic polyimides, thermoplastic polyamideimides, thermoplastic polyetherimides, and thermoplastic polyesterimides. Among these, thermoplastic polyesterimides are particularly preferable from the standpoint of low moisture absorption.

In the present invention, “thermoplastic polyimide” refer to one having a glass transition point and undergoes permanent set in the temperature range of 10 to 400° C. (heating rate: 10° C./min) in thermal mechanical analysis (TMA) in a compression mode (probe diameter: 3 mm, load: 5 g).

The thermoplastic polyimide used in the present invention preferably has a glass transition point (Tg) in the range of 150° C. to 300° C. so that lamination with a conventional apparatus is possible and that the heat resistance of the resulting metal-clad laminate is not degraded. The glass transition point can be determined from the inflection point of storage modulus observed with a dynamic mechanical analyzer (DMA).

The thermoplastic polyimide is prepared by imidizing a polyamic acid, which is a precursor. The precursor of the thermoplastic polyimide is not particularly limited, and any known polyamic acid may be used. Known starting materials, reaction conditions, and the like may be used for the production. If necessary, an organic or inorganic filler may be added.

(III) Production of Adhesive Film

The adhesive film of present invention is prepared by forming an adhesive layer containing a thermoplastic polyimide on at least one surface of a particular polyimide film prepared by the above-described continuous process. Preferable examples of the production method include a method in which an adhesive layer is formed on a polyimide film, which is a base film; and a method in which a sheet of an adhesive layer is prepared separately and then bonded to the polyimide film. According to the former method, the solubility in an organic solvent may decrease and the formation of the adhesive layer on the polyimide film may thus become difficult if the polyamic acid, which is contained in the adhesive layer and is a precursor of the thermoplastic polyimide, is completely imidized. Thus, preferably, from the above standpoint, a solution of the polyamic acid, i.e., the precursor of the thermoplastic polyimide, is prepared and applied on the base film, followed by imidization.

The method for flow-casting or applying the polyamic acid solution onto the polyimide film is not particularly limited. A conventional method such as die coating, reverse coating, or blade coating may be employed. The effects of the present invention are particularly noticeable when the adhesive layer is formed by a continuous process. In detail, the polyimide film may the wound into a roll and then unreeled while the polyamic acid-precursor of thermoplastic polyimide-containing solution is continuously applied onto the polyimide film. The polyamic acid solution may contain other components, such as a filler, depending on the usage. The thickness of each layer of the heat resistant adhesive film can be adequately adjusted so that the total thickness is optimum for the usage. It necessary, surface treatment, such as corons discharge treatment, plasma-enhanced treatment, or coupling treatment may be performed on the surface of the core film before formation of the adhesive layer.

As the process of imidization, a thermal cure technique or a chemical cure technique may be employed. In both the technique, heating is performed to efficiently conduct the imidization. The temperature is preferably set in the range of (Tg of thermoplastic polyimide minus 100° C.)−(Tg of thermoplastic polyimide plus 200° C.) and more preferably in the range of (Tg of thermoplastic polyimide minus 50° C.)−(Tg of thermoplastic polyimide plus 150° C.). According to the thermal cure technique, imidization readily occurs at higher temperatures, and the curing rate can be increased, which is preferable from the standpoint of productivity. However, at an excessively high temperature, the thermoplastic polyimide may become thermally decomposed. In contrast, at an excessively low temperature, imidization is not easy even by the chemical cure technique and does not proceed smoothly, thereby requiring a longer time to cure.

The imidization time should be long enough to substantially finish imidization and drying and is not particularly defined. Typically, the imidization time is set in the range of about 1 to 600 seconds. In order to improve the melt flowability of the adhesive layer, the imidization ratio may be intentionally decreased and/or the solvent may be intentionally left.

The tension applied during the imidization is 1 to 15 kg/m and preferably 5 to 10 kg/m in the MD direction. When the tension is below the range, the film may sag during the transfer and may not be uniformly wound into a roll. When the tension is over the above-described range, the film is heated to a high temperature while high tension is being applied to the adhesive film. Thus, even when the core film is oriented in the MD direction, thermal stress will be generated in the adhesive film, thereby adversely affecting dimensional changes.

(V) Flexible Metal-clad Laminate and Method For Making the Laminate

The flexible metal-clad laminate of the present invention is made by bonding a metal foil onto the adhesive film described above. The metal foil used is not particularly limited. When the flexible metal clad laminate of present invention is used for electronic and electric device applications, the metal foil may be composed of copper, a copper alloy, stainless steel, a stainless steel alloy, nickel, a nickel alloy (including alloy 42), aluminum, or an aluminum alloy. A typical flexible metal-clad laminate frequently use a copper foil such as a rolled copper foil or an electrolytic copper foil. These foils are also preferred in the present invention. The surface of the metal foil may be covered with an antirust layer, a heat-resistant layer, or the like or treated with a coupling agent to increase the adhesiveness. In the present invention, the thickness of the metal foil is not particularly limited. The thickness should be adjusted so that sufficient functions suitable for the use can be exhibited.

The effects of the adhesive film of present invention are particularly noticeable when the bonding of the metal foil onto the basic film is conducted by a continuous process using a hot roll laminator including one or more pairs of metal rollers or a double bell press (DBP). The adhesive film may be slit into a film having an adequate width and then bonded with the metal foil in the continuous process. The effects of the present invention are particularly noticeable when the film width is 250 mm or more since the ratio of change in dimensions is decreased and is stable across the entire width.

The bonding of the metal layer is preferably conducted with a hot roll laminator including one or more pairs of metal rollers, since the hot roll laminator has a simple configuration and requires low maintenance cost.

When the hot roll laminator is used, the dimensions of the film easily change. The adhesive film of the present invention is particularly advantageous when bonding is conducted with a hot roll laminator having one or more pairs or metal rollers. Here, “hot roll laminator having one or more pairs of metal rollers” may be any device equipped with metal rollers for heating and pressing a workpiece, and the structure of the device is not particularly limited.

The specific process for conducting the thermal lamination is not particularly limited. In order to improve appearance of the resulting laminate, a protective material is preferably interposed between the pressed surface and the metal foil. The protective material may be any material that can withstand the heating temperature during the thermal lamination. Examples thereof include heat-resistant plastics, such as non-thermoplastic polyimide films, and metal foils such as copper foils, aluminum foils, and SUS (stainless steel) foils. Among these, non-thermoplastic polyimide films are preferable from the standpoint of good balance between the heat resistance and recyclability. The thickness of the non-thermoplastic polyimide film is preferably 75 μm or more since an excessively thin film does not exhibit sufficient cushioning and protecting effects during the lamination.

The protective material need not be a single layer and may have a multilayer structure constituted from two or more layers having different properties.

In the thermal lamination, the method for heating the materials to be laminated is not particularly limited. A known heating method that can heat the material at a predetermined temperature can be used. Examples of such a method include a heat circulation method, a hot-air heating method, and an induction heating method. The method for pressuring the material to be laminated in the thermal lamination is also not particularly limited and any conventional technique that can apply a predetermined pressure can be employed. Examples thereof include a hydraulic method, an air pressure method, and a gap frame pressing method.

The heating temperature during the thermal lamination, i.e., the lamination temperature, is preferably at least 50° C. higher and more preferably at least 100° C. higher than the glass transition point (Tg) of the adhesive film. At a temperature of Tg 150° C. or higher, the adhesive film can be satisfactorily thermally laminated with the metal foil. At a temperature of Tg 1100° C. or higher, the lamination rate can be increased to further increase the productivity.

The effects of the present invention are particularly noticeable when the heating temperature is 200° C. or more and preferably 300° C. or more. The adhesive film of present invention has a thermoplastic polyimide-containing adhesive layer on at least one surface of the polyimide film and thus exhibits heat resistance. In general, when a thermoplastic polyimide is contained in the adhesive layer, a temperature as high as 200° C. or more or, in some cases, near 400° C. must be applied to yield heat bondability. Thus, residual strain is generated in the flexible metal-clad laminate prepared by the lamination, and dimensions change during etching for forming wiring or during solder reflow for mounting a component. In contrast, the adhesive film of present invention includes a polyimide film having particular physical properties across the entire width. Thus, even when lamination is conducted at high temperature, the ratio of change in dimensions is small, and a flexible metal-clad laminate having a stable ratio of change in dimensions across the entire width can be obtained.

The lamination rate during the above described thermal lamination step is preferably 0.5 m/min or more and more preferably 1.0 m/min or more. At a rate of 0.5 m/min or more, sufficient thermal lamination is possible. At rate of 1.0 m/min or more, the productivity can be further improved.

As the pressure during the thermal lamination step, i.e., the lamination pressure, increases, the required lamination temperature decreases and the lamination rate increases. At an excessively high lamination pressure, however, the dimensional changes of the laminate obtained thereby may become greater. At an excessively low lamination pressure, the bonding strength between the metal foil and the resulting laminate may be decreased. Thus, the lamination pressure is preferably in the range of 49 to 490 N/cm (5 to 50 kgf/cm) and more preferably in the range of 98 to 294 N/cm (10 to 30 kgf/cm). Within these ranges, the three conditions, i.e., the lamination temperature, the lamination rate, and the lamination pressure, can be adjusted to satisfactory levels, and the productivity can be further increased.

The tension applied to the adhesive film during the lamination step is preferably 0.01 to 4 N/cm, more preferably 0.02 to 2.5 N/cm, and most preferably 0.05 to 1.5 N/cm. At a tension below this range, the film may sag or meander during the transfer for the lamination and may not be sent to the heating rollers in a uniform manner. Thus, it may be difficult to obtain a flexible metal-clad laminate having good appearance. At a tension above this range, the influence of the tension is so strong that it cannot be moderated by controlling the glass transition point and the storage modulus of the adhesive layer. Thus, the dimensional stability may be decreased.

In order to produce the flexible metal-clad laminate of present invention, a thermal laminator that can continuously heat and press the materials to be laminated is preferably used. In the thermal laminator, a lamination material feeding unit for feeding the materials to be laminated may be provided upstream of the thermal laminator, and a lamination material take-up unit for taking up the materials to be laminated may be provided downstream of the thermal laminator. These units can help increase the productivity of the thermal laminator. The configurations of the lamination material feeding unit and the lamination material take-up unit are not particularly limited. For example, any known roll-shaped take-up machine that can take-up an adhesive film, a metal foil, or a laminated product can be used.

More preferably, a protective material take-up unit and a protective material feeding unit for winding and feeding a protective material are provided. With these units, the protective material used once in the thermal lamination process can be recovered by the taking-up operation, and the recovered protective material can be set to the feeding unit to reuse the protective material. In order to align the ends of the protective material during the take-up operation, an end position detecting unit and a take-up position correcting unit may be provided. In this manner, the ends of the protective material can be accurately aligned and taken-up, thereby increasing the recycling efficiency. The configuration of the protective material take-up unit, the protective material feeding unit, the end position detecting unit, and the take-up position correcting unit are not particularly limited. Various known apparatuses may be used.

With respect to the flexible metal-clad laminate obtained by the production method of present invention, the total of the ratio of change in dimensions before and after the removal of the metal foil and the ratio of change in dimensions before and after 30 minutes of heating at 250° C. conducted after the metal foil removal is particularly preferably in the range of −0.06 to +0.06 in both MD and TD directions. The ratio of change in dimension before and after the removal of the metal foil is defined as a ratio of the difference between a particular dimension of the flexible metal-clad laminate before etching and the dimension after the etching to the particular dimension of the flexible metal-clad laminate before the etching. The ratio of change in dimensions before and after the heating is defined as a ratio of the difference between a particular dimension of the flexible metal-clad laminate before the heating and the dimension after the heating to the particular dimension of the flexible metal-clad laminate before the heating.

When the ratio of change in dimensions is outside this range, the resulting flexible metal-clad laminate may undergo substantially large changes in dimensions when fine wiring is formed and when a component is mounted thereon. Thus, the position for mounting the component may deviate from the designed position. As a consequence, a substrate may not satisfactorily couple with a component mounted thereon. In other words, by adjusting the ratio of change in dimensions in the above-described range, it becomes possible to assume that the laminate is suitable for mounting components.

The technique of measuring the ratio of change in dimensions is not particularly limited. Any known method that can measure the increase or decrease that occur before and after the etching or heating of the flexible metal-clad laminate may be employed.

The ratio of change in dimensions must be measured in both the MD and TD directions. When imidization and lamination are conducted continuously, the tension applied in the MD direction differs from that applied in the TD direction. Thus, the degree of thermal expansion and contraction in the MD direction differs from that in the TD direction, and the same applies to the ratio of change in dimensions. Thus, with respect to a material whose the ratio of change is small, the ratio of change must be small in both the MD and TD directions. In this invention, the total of the ratio of change in dimensions before and after the removal of the metal foil and the ratio of change in dimensions before and after 30 minutes of heating at 250° C. conducted after the metal foil removal particularly preferably in the range of −0.06 to +0.06 in the MD and TD directions.

The conditions of the etching step for the measurement of the ratio of change in dimensions are not particularly limited. Etching conditions vary depending on the type of metal foil, the shape of the patterned wiring, and the like. The conditions of the etching for the measurement of the ratio of change in dimensions may be any known conditions. Similarly, in the heating step, the conditions are not particularly limited as long as heating conducted at 250° C. for 30 minutes.

The flexible metal-clad laminate obtained by the method of the present invention can be used as a flexible wiring board having miniaturized and densified components mounted thereon. This is done by etching the metal foil of the flexible metal-clad laminate to form a desired patterned wiring, as described above. It is needless to say that the application of the present invention is not limited to this. The present invention can be applied to any usage that requires a laminate including a metal foil.

When the present invention is applied to an adhesive foil 250 mm or more in width produced by a continuous process, the invention has the advantages of not only a small ratio of change in dimensions but also a stable ratio of change in dimensions across the entire width of the film.

### EXAMPLES

The present invention will now be described by way of examples. It should be understood that the examples in no way limit the scope of the invention. The evaluation of the molecular orientation angle of the film of each of EXAMPLES and COMPARATIVE EXAMPLES was conducted as follows.

[Molecular Orientation Angle of Film]

Specimens 4 cm×4 cm each were cut out from the original film at equally spaced positions in the width direction. The direction of transfer was marked on each specimen, and the measurement was conducted with a molecular orientation analyzer.

MOR-c was determined with a microwave molecular orientation analyzer MOA 2012A produced by KS Systems Inc. The MOR-c values observed with MOA2012A were in proportion to the thickness. The MOR-c was calculated from the MOR value observed with the analyzer as above according to the following equation by converting the observed MOR values to the equilvalents of a thickness of 75 μm:
MOR-c=(tc/t×(MOR−1))+1
wherein t was the thickness of a specimen, to was a reference thickness for conversion, MOR was a value observed by the above-described measurement, and MOR-c was a converted MOR value.

In the equation above, the converted MOR (MOR c) was calculated by setting to as 75. The closer MOR-c is to 1.000, the more isotropic is the film.

The x axis was taken in the longitudinal direction (MD direction) at the center of the film, and the direction in which the polyamic acid traveled when the polyamic acid was flow-cast on a support was defined as the positive direction. The angle defined by the x axis in the positive direction and the orientation axis analyzed as above was defined as θ. When the orientation axis lay in the first and third quadrants, the orientation axis angle was defined as positive (0°<0≦90°). When the orientation axis lay in the second and fourth quadrants, the orientation axis angle was defined as negative (−90°≦θ<0°).

The specimens were taken as illustrated in FIGS. 13A and 13B.

(Glass Transition Point)

The glass transition point was measured with DMS200 produced by Seiko Instruments Inc., at a heating rate of 3° C./min in the temperature range of room temperature to 400° C., and the glass transition point as defined as the inflection point of the storage modulus.

(Determination of Thermoplasticity)

The specimen was tested to determine whether permanent set occurred in the temperature range of 10 to 400° C. (heating rate 10° C./min) in thermal mechanical analysis (TMA) under a compression mode (probe diameter: 3 mm, load: 5 g)

(Thickness Measurement)

The thickness of the film was measured at ten equally spaced points in the TD direction, and the average thickness was defined as the film thickness. A length gauge MT12 produced by Heidenhain Corporation was used in the measurement. The film thicknesses of EXAMPLES 7 to 10 and 15 before and after treatment are shown in Table 14.

(Ratio of Change in Dimensions of Flexible Laminate)

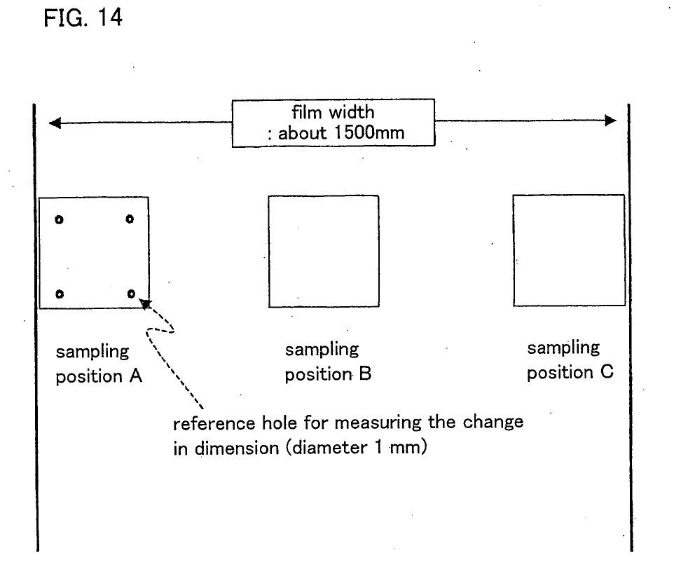

As shown in FIG. 14, four holes were formed in a flexible copper-clad laminate and the distance between the holes was measured according to Japanese Industrial Standards (JIS) C6481. The laminate was then etched to remove the metal foil from the flexible laminate, and the resulting laminate was left to stand in a thermostatic chamber at 20° C. and 60% RH for 24 hours. The distance between the four holes was again measured in the same manner as before the etching. The ratio of change in dimensions was calculated based on the equation below:
ratio of change in dimension (%)−{(D2−D1)/D1)}×100
wherein D1 is the observed distance between the holes before the removal of the metal foil and D2 is the observed distance between the holes after the removal of the metal foil.

The ratio of change in dimensions was measured in the MD direction, the TD direction, 45° to the right, and 45° to the left.

The ratio of change in dimensions after heating was determined in EXAMPLES 26 to 33 and COMPARATIVE EXAMPLES 5 and 6. In detail, after the above-described operation, the specimen after the etching was heated at 250° C. for 30 minutes and left to stand in a thermostatic chamber at 20° C. and 60% RH for 24 hours. The distance between the four holes was measured. The ratio of change in dimensions before and after the heating was determined by the following equation:
ratio of change in dimension (%)={(D3−D2)/D2}×100
wherein D3 is the distance between the holes after the heating.

The ratio of change in dimensions was measured in both the MD and TD directions.

(Peeling Strength of Metal Foil: Bonding Strength)

A specimen was prepared, and a 5-mm portion of a metal foil was peeled at a peeling angle of 180° at 50 mm/min to measure the load according to Japanese Industrial Standards (JIS) C6471, “6.5. Peeling strength”.

### Example 1

Pyromellitic dianhydride, p-phenylene bis(trimellitic acid monoester anhydride), 4,4′-diaminodiphenyl ether, and p-phenylenediamine at a molar ratio of 1/1/1/1 were polymerized in the presence of an N,N′-dimethylacetamide solvent so that the solid content was 18%.

The polymer solution was cooled to about 0° C. and combined with 2.1 mol % of acetic anhydride and 1.1 mol % of isoquinoline per mole of amic acid in the polyamic acid organic solvent solution cooled to about 0° C. The resulting mixture was thoroughly stirred, extruded from a die, and applied on an endless belt by flow casting. The cast solution was heated at 140° C. or less on the endless belt to obtain a self-supporting gel film (green sheet) having a residual component ratio of 54%. The green sheet was peeled and the ends thereof were fixed onto pin seats for continuously transferring the film so that the film was lightly stretched across the pin seats. The film was then transferred through hot blast furnaces (first to third), far-infrared furnace, and a slow-cooling furnace, whose temperatures are described at table 1. The temperatures was shown in table 1. The film was removed from the pin seats after the film was discharged from the slow-cooling furnace. The film was wound and a polyimide film having a width of about 1.5 m and a thickness of 18.5 μm was obtained thereby. The contraction ratio is shown in Table 2. The step of decreasing the distance between the pin seats so that substantially no tension was applied in the TD direction was completed before the film was transferred into the furnace. The step of increasing the distance between the pin seats was conducted in the third hot blast furnace. In the table, “IR furnace” denotes a far-infrared furnace.

### Example 2

A film was prepared as in EXAMPLE 1 except that the contraction ratio and the expansion ratio (also referred to as contraction/expansion ratio) were adjusted as shown in Table 2.

### Example 3

A film was prepared as in EXAMPLE 1 except that the contraction ratio, the expansion ratio, and the heating conditions were adjusted as shown in Tables 1 and 2.

### Example 4

A film was prepared as in Example 1 except that the contraction ratio, the expansion ratio, and the heating conditions were adjusted as shown in Tables 1 and 2.

### Comparative Example 1

A film was prepared as in Example 1 except that the contraction ratio, the expansion ratio, and the heating conditions were adjusted as shown in Tables 1 and 2.

### Example 5

Pyromellitic dianhydride, p-phenylene bis(trimellitic acid monoester anhydride), 4,4′-diaminodiphenyl ether, and p-phenylenediamine at a molar ratio of 1/1/1/1 were polymerized in the presence of an N,N′-dimethylacetamide solvent so that the solid content was 18%.

The polymer solution was cooled to about 0° C. and combined with 2.1 mol % of acetic anhydride and 1.1 mol % of isoquinoline per mole of amic acid in the polyamic acid organic solvent solution cooled to about 0° C. The resulting mixture was thoroughly stirred, extruded from a die, and applied on an endless belt by flow casting. The cast solution was heated at 140° C. or less on the endless belt to obtain a self-supporting gel film (green sheet) having a residual component ratio of 60%. The green sheet was peeled and the ends thereof were fixed onto pin seats for continuously transferring the film so that the film was tightly stretched across the pin seats. The film was then transferred through hot blast furnaces, a far-infrared furnace, and a slow-cooling furnace. The film was removed from the pin seats after the film was discharged from the slow-cooling furnace. The film was wound and a polyimide film having a width of about 0.5 m and a thickness of 18.5 μm was obtained thereby.

The construction ratio and the expansion ratio are shown in Table 4. The step of decreasing the distance between the pin seats so that substantially no tension was applied in the TD direction was completed before the film was transferred into the furnace. The step of increasing the distance between the pin seats was conducted in the fourth furnace. The atmospheric temperatures and the retention time for the hot blast furnaces (first to fourth), the far-infrared furnace, and the slow-cooling furnace are shown in Table 3.

### Example 6

A film was prepared as in EXAMPLE 5 except that the contraction ratio, the expansion ratio, and the heating conditions were changed as in Tables 3 and 4.

### Comparative Example 2

A film was prepared as in EXAMPLE 5 except that the contraction ratio, the expansion ratio, and the heating conditions were changed as in Tables 3 and 4.

### Example 7

Pyromellitic dianhydride, p-phenylene bis(trimellitic acid monoester anhydride), 4,4′-diaminodiphenyl ether, and p-phenylenediamine at a molar ratio of 1/1/1/1 were polymerized in the presence of an N,N′-dimethylacetamide solvent so that the solid content was 18%.

The polymer solution was cooled to about 0° C. and combined with 2.1 mol % of acetic anhydride and 1.1 mol % of isoquinoline per mole of amic acid in the polyamic acid organic solvent solution cooled to about 0° C. The resulting mixture was thoroughly stirred, extruded from a die, and applied on an endless belt by flow casting. The cast solution was heated at 140° C. or less on the endless belt to obtain a self-supporting gel film (green sheet) having a residual component ratio of 23%. The green sheet was peeled and the ends thereof were fixed onto pin seats for continuously transferring. The film was then transferred through hot blast furnaces, a far-infrared furnace, and a slow-cooling furnace. The film was removed from the pin seats after the film was discharged from the slow-cooing furnace. The film was wound and a polyimide film having a width of about 1.5 m and a thickness of 18.5 μm was obtained thereby. The atmospheric temperatures and the retention time for the hot blast furnaces (first to third), the far-infrared furnace, and the slow cooling furnace are shown in Table 5.

Next the resulting film was heated in a far-infrared furnace by a roll-to-roll process as the post treatment. The conditions of the heating, i.e., the post treatment, are shown in Table 5.

### Example 8

A film was prepared as in EXAMPLE 7 except that the tension during the post treatment was changed to 12.7 kg/m and the furnace for the post treatment as changed to a hot-blast furnace.

### Example 9

Pyromellitic dianhydride, 4,4′-diaminodiphenyl ether, and p-phenylenediamine at a molar ratio of 1/0.75/0.25 were polymerized in the presence of an N,N′-dimethylacetamide solvent so that the solid content was 18%. In detail, 75 mol % of 4,4′-diaminodiphenyl ether relative to the total diamine content was dissolved in an N,N′-dimethylacetamide solvent, the total amount of pyromellitic dianhydride (i.e., 1133% of acid anhydride relative to the diamine component already added) was added thereto to prepare an acid-terminated prepolymer. The acid-terminated prepolymer solution was combined with the rest of the diamine component (i.e., the remaining p-phenylenediamine) so that the diamine component was substantially equimolar with the total or the acid component, and the resulting mixture was reacted to obtain a polymer solution.

The polymer solution was cooled to about 0° C. and combined with 2.0 mol % of acetic anhydride and 0.5 mol % of isoquinoline per mole of amic acid in the polyamic acid organic solvent solution cooled to about 0° C. The resulting mixture was thoroughly stirred, extruded from a die, and applied on an endless belt by flow casting. The cast solution was heated at 140° C. or less on the endless belt to obtain a self-supporting gel film (green sheet) having a residual component ratio of 30%. The green sheet was peeled and the ends thereof were fixed onto pin seats for continuously transferring the film. The film was then transferred through hot blast furnaces (first to third), a far-infrared furnace, and a slow-cooling furnace. The film was removed from the pin seats after the film was discharged from the slow-cooling furnace. The film was wound and a polyimide film having a width of about 1.5 m and a thickness of 25 μm was obtained thereby. The atmospheric temperatures and the retention time for the hot blast furnaces (first to third), the far-infrared furnace, and the slow-cooling furnace are shown in Table 5.

Next the resulting film was heated in a hot blast IR furnace (a heating furnace employing both hot blast and far-infrared heater) by a roll-to-roll process as the post treatment while applying a tension in the MD direction. The conditions of the heating, i.e., the post treatment, are shown in Table 5.

### Example 10

A film was prepared as in EXAMPLE 9 except that the tension during the post treatment was changed.

### Example 11

Pyromellitic dianhydride, p-phenylene bis(trimellitic acid monoester anhydride) 4,4′-diaminediphenyl ether, and p-phenylenediamine at a molar ratio of 1/1/1/1 were polymerized in the presence of an N,N′-dimethylacetamide solvent so that the solid content was 18%.

The polymer solution was cooled to about 0° C. and combined with 2.1 mol % of acetic anhydride and 1.1 mol % of isoquinoline per mole or amic acid in the polyamic acid organic solvent solution cooled to about 0° C. The resulting mixture was thoroughly stirred, extruded from a die maintained at about 5° C., and applied on an endless belt by flow casting. The cast solution was heated and dried on the endless belt to prepare a gel film having a residual component ratio of 54%.

The gel film (self-supporting green sheet) was peeled, and the both ends thereof are fixed onto pin seats for continuously transferring the sheet. The film was then transferred through hot blast furnaces, a far-infrared furnace, and a slow-cooling furnace. The film was removed from the pin seats after the film was discharged from the slow-cooling furnace. The film was wound and a polyimide film having a width of 1.5 m and a thickness of 18 μm was obtained thereby.

The atmospheric temperatures and the retention time for the hot blast furnaces (first to third), the far-infrared furnace, and the slow-cooling furnace are shown in Table 10. The contraction ratio, the expansion ratio, and the angle of the molecular orientation axis of the resulting film are shown in Table 11. The step of decreasing the distance between the pin seats so that substantially no tension was applied in the TD direction was completed before the film was transferred into the furnace. The step increasing the distance between the pin seats was conducted in the third hot blast furnace. In the table, “IR furnace” denotes a far-infrared furnace.

### Example 12

A film was prepared as in EXAMPLE 11 except that the contraction ratio, the expansion ratio, and the heating conditions were changed as in Tables 10 and 11. The angle of the molecular orientation axis of the resulting film is shown in Table 11.

### Example 13

A film was prepared as in EXAMPLE 11 except that the contraction ratio, the expansion ratio, and the heating conditions were changed as in Tables 10 and 11. The angle of the molecular orientation axis or the resulting film is shown in Table 11.

### Example 14

A film was prepared as in EXAMPLE 11 except that the contraction ratio, the expansion ratio, and the heating conditions were changed as in Tables 10 and 11. The angle of the molecular orientation axis of the resulting film is shown in Table 11.

### Example 15

Pyromellitic dianhydride, p-phenylene bis(trimellitic acid monoester anhydride), 4,4′-diaminodiphenyl ether, and p-phenylenediamine at a molar ratio of 1/1/1/1 were polymerized in the presence of an N,N′-dimethylacetamide solvent so that the solid content was 18%.

The polymer solution was cooled to about 0° C. and combined with 2.1 mol % of acetic anhydride and 1.1 mol % of isoquinoline per mole of amic acid in the polyamic acid organic solvent solution cooled to about 0° C. The resulting mixture was thoroughly stirred, extruded from a die maintained at about 5° C., and applied on an endless belt by flow casting. The cast solution was heated and dried on the endless belt to prepare a gel film having a residual component ratio of 23%. The gel film (self-supporting green sheet) was peeled, and the both ends thereof are fixed onto pin seats for continuously transferring the sheet. The film was then transferred through hot blast furnaces, a far-infrared furnace, and a slow-cooling furnace. The film was removed from the pin seats after the film was discharged from the slow-cooling furnace. The film was wound and a polyimide film having a width of about 1.5 m and a thickness of 18.5 μm was obtained thereby. A roll-to-roll post treatment was performed with an TR furnace to obtain a film.

The atmospheric temperatures and the retention time for the hot blast furnaces (first to third), the far-infrared furnace, and the slow-cooling furnace and the conditions of the post treatment, i.e., a thermal stretching process, are shown in Table 12.

### Synthetic Example 1

### Synthesis of Thermoplastic Polyimide Precursor

In a 1,000 ml, glass flask, 600 g of DMF and 82.1 g of 2,2′-bis[4-4-aminophenoxy)phenyl]propane (hereinafter also referred to as BAPP) were introduced, and the resulting mixture was stirred under a nitrogen atmosphere while gradually adding 53.0 g of 3,3′,4,4′-biphenyltetracarboxylic dianhydride (hereinafter also) referred to as BPDA). Subsequently, 4.1 g of 3,3′,4,4′-ethylene glycol dibenzoate tetracarboxylic dianhydride (hereinafter also referred to as TMEG) was added, and the resulting mixture was stirred for 30 minutes in an ice bath. A solution of 4.1 g of TMEG in 20 g of DMF was separately prepared, and this solution was gradually added to the reaction solution while monitoring the viscosity under stirring. The addition and stirring were discontinued after the viscosity reached 3,000 poise, thereby obtaining a polyamic acid solution. The polyimide resin obtained was thermoplastic.

The glass transition point of the thermoplastic polyimide was determined as follows. The thus prepared polyamic acid solution was flow-cast onto a 25 μm PET film (Cellapeel HP, produced by Toyo Metallizing Co., Ltd.) so that the final thickness was 20 μm and dried at 120° C. for 5 minutes. The resulting self-supporting film after the drying was peeled from the PET film, fixed onto a metal pin frame, and dried at 150° C. for 5 minutes, at 200° C. for 5 minutes, at 250° C. for 5 minutes, and at 350° C. for 5 minutes. The single-layer sheet thus obtained was analyzed to measure the glass transition point. The glass transition point was 235° C.

### Synthetic Example 2

### Synthesis of Thermoplastic Polyimide Precursor

Into a 2,000 mL glass flask, 780 g of DMF and 115.6 g of 2,2-bis[4-(4-aminophenoxy)phenyl]propane (hereinafter also referred to as BAPP) were introduced, and the resulting mixture was stirred under a nitrogen atmosphere while 78.7 g of BPDA was gradually added thereto. Subsequently, 3.8 g of TMEG (ethylene glycol dibenzoate tetracarboxylic dianhydride) was added to this reaction solution, and the mixture was stirred for 30 minutes in an ice bath. A solution of 2.0 g of TMEG in 20 g of DMF was separately prepared, and this solution was gradually added to the reaction solution while monitoring the viscosity under stirring. The addition and the stirring were discontinued after the viscosity reached 3,000 poise, thereby obtaining a polyamic acid solution.

The polyimide resin obtained was thermoplastic.

The glass transition point of the thermoplastic polyimide was determined as follows. The polyamic acid solution thus prepared was flow-cast onto a 25-μm PET film (Cellapeel HP, produced by Toyo Metallizing Co., Ltd.) so that the final thickness was 20 μm, and dried at 120° C. for 5 minutes. The resulting self-supporting film after the drying was peeled from the PET film, fixed onto a metal pin frame, and dried at 150° C. for 5 minutes, at 200° C. for 5 minutes, at 250° C. for 5 minutes, and at 350° C. for 5 minutes. The single-layer sheet thus obtained was analyzed to measure the glass transition point. The glass transition point of the thermoplastic polyimide was 240° C.

### Synthetic Example 3

### Synthesis of Thermoplastic Polyimide Precursor

Into a 2,000 ml, glass flask, 790 g of DMF and 107.5 g of BAPP were introduced, and the resulting mixture was stirred under a nitrogen atmosphere while gradually adding 54.9 g of benzophenenetetracarboxylic dianhydride (hereinafter also referred to as BTDA). Subsequently, 34.6 g of TMEG was added, and the resulting mixture was stirred for 30 minutes in an ice bath. A solution of 3.0 g of TMEG in 20 g of DMF was separately prepared and then gradually added to the above-described reaction solution while monitoring the viscosity under stirring. The addition and stirring were discontinued after the viscosity reached 3,000 poise, thereby obtaining a polyamic acid solution.

The polyimide resin obtained was thermoplastic.

The glass transition point of the thermoplastic polyimide was determined as follows. The polyamic acid solution thus prepared was flow-cast onto a 2.5-μm PET film (Cellapeel HP, produced by Toyo Metallizing Co., Ltd.) so that the final thickness was 20 μm, and dried at 120° C. for 5 minutes. The resulting self-supporting film after the drying was peeled from the PET film, fixed onto a metal pin frame, and dried at 150° C. for 5 minutes, at 200° C. for 5 minutes, at 250° C. or 5 minutes, and at 350° C. for 5 minutes. The single-layer sheet thus obtained was analyzed to measure the glass transition point. The glass transition point was 190° C.

### Examples 16 to 25 and Comparative Examples 3 and 4

The polyamic acid solution obtained in SYNTHETIC EXAMPLE 1 was diluted with DMF until the solid content was 10 wt %. Each of the polyimide films obtained in EXAMPLES 1 to 10 and COMPARATIVE EXAMPLES 1 and 2 was processed as below to prepare a flexible copper-clad laminate. The polyamic acid was applied onto both surfaces of the polyimide film so that the final thickness of the thermoplastic polyimide layer (adhesive layer) was 3 μm on each surface. Heating was conducted at 120° C. for 4 minutes, and then imidization was conducted by heating at 390° C. for 20 seconds, thereby obtaining an adhesive film.

A 18-μm rolled copper foil (BHY-22B-T, produced by Japan Energy Corporation) was disposed on each surface of the adhesive film, and a protective material (Apical 125NPI produced by Kaneka Corporation) was applied on each copper foil on the surface to form a composite. The composite was continuously thermally laminated with a hot roll laminator at a lamination temperature of 360° C., a lamination pressure of 196 N/cm (20 kgl/cm), an adhesive film tension of 0.07 N/cm, and a lamination rate of 1.5 m/min to prepare a flexible metal-clad laminate. The estimated properties of resultant the flexible metal-clad laminates are shown in tables 7, 8, and 9.

### Example 26

The polyamic acid solution obtained in SYNTHETIC EXAMPLE 2 was diluted with DMF until the solid content was 10 wt %. The polyamic acid was applied onto both surfaces of the polyimide film (film width: 1,500 mm) obtained in EXAMPLE 11 so that the final thickness of the thermoplastic polyimide layer (adhesive layer) was 4 μm on each surface. Heating was conducted at 140° C. for 1 minute, and then thermal imidization was conducted by passing the film through an infrared heating furnace having an atmospheric temperature 390° C. for 20 seconds while applying a tension of 5 kg/m to obtain an adhesive film. A 18-μm rolled copper foil (BHY-22B-T, produced by Japan Energy Corporation) was disposed on each surface of the adhesive film, and a protective material (Apical 125NPI produced by Kaneka Corporation) was applied on each copper foil on the surface to form a composite. The composite was subjected to continuous hot roll lamination at a polyimide film tension of 0.4 N/cm, a temperature of 360° C., a lamination pressure of 196 N/cm (20 kgf/cm), and a lamination rate of 1.5 m/min to prepare a flexible metal clad laminate of the present invention.

### Example 27

An adhesive film and a flexible metal-clad laminate were prepared as in EXAMPLE 26 except that the polyimide film obtained in EXAMPLE 12 was used instead of the polyimide film obtained in EXAMPLE 11.

### Example 28

An adhesive film and a flexible metal-clad laminate were prepared as in EXAMPLE 26 except that the polyimide film obtained in EXAMPLE 13 was used instead of the polyimide film obtained in EXAMPLE 11.

### Example 29

The polyamic acid solution obtained in SYNTHETIC EXAMPLE 3 was diluted with DMF until the solid content was 10 wt %. The polyamic acid was applied onto both surfaces of the polyimide film obtained in EXAMPLE 11 so that the final thickness of the thermoplastic polyimide layer (adhesive layer) was 4 μm on each surface. Heating was conducted at 140° C. for 1 minute. Then thermal imidization was conducted by passing the film through a far-infrared heating furnace having an atmospheric temperature of 330° C. for 20 seconds to obtain an adhesive film. A 18-μm rolled copper foil (BHY-22B-T, produced by Japan Energy Corporation) was disposed on each surface of the adhesive film, and a protective material (Apical 125NPI produced by Kaneka Corporation) was applied on each copper foil on the surface to form a composite. The composite was subjected to continuous hot roll lamination at a polyimide film tension of 0.4 N/cm, a lamination temperature of 330° C., a lamination pressure of 196 N/cm (20 kgf/cm), and a lamination rate of 1.5 m/min to prepare a flexible metal-clad laminate of the present invention.

### Example 30

An adhesive film and a flexible metal-clad laminate were prepared as in EXAMPLE 29 except that polyimide film obtained in EXAMPLE 12 was used instead of the polyimide film obtained in EXAMPLE 11.

### Example 31

An adhesive film and a flexible metal-clad laminate were prepared as in EXAMPLE 29 except the polyimide film obtained in EXAMPLE 13 was used instead of the polyimide film obtained in EXAMPLE 11.

### Example 32

The polyamic acid solution obtained in SYNTHETIC EXAMPLE 2 was diluted with DMF until the solid content was 10 wt %. The polyamic acid was applied onto both surfaces of the polyimide film obtained in EXAMPLE 15 so that the final thickness of the thermoplastic polyimide layer (adhesive layer) was 4 μm on each surface. Heating was conducted at 140° C. for 1 minute. Then thermal imidization was conducted by passing the film through a far-infrared heating furnace having an atmospheric temperature of 390° C. for 20 seconds to obtain an adhesive film. A 18-μm rolled copper foil (BHY-22B-T, produced by Japan Energy Corporation) was disposed on each surface of the adhesive film, and a protective material (Apical 125NPI produced by Kaneka Corporation) was applied on each copper foil on the surface to form a composite. The composite was subjected to continuous hot roll lamination at a polyimide film tension of 0.4 N/cm, a lamination temperature of 360° C., a lamination pressure of 196 N/cm (20 kgf/cm), and a lamination rate of 1.5 m/min to prepare a flexible metal-clad laminate of the present invention.

### Example 33

The polyamic acid solution obtained in SYNTHETIC EXAMPLE 3 was diluted with DMF until the solid content was 10 wt %. The polyamic acid was applied onto both surfaces of the polyimide film obtained in EXAMPLE 15 that the final thickness of the thermoplastic polyimide layer (adhesive layer) was 4 μm on each surface. Heating was conducted at 140° C. for 1 minute. Then thermal imidization was conducted by passing the film through a far-infrared heating furnace having an atmospheric temperature of 330° C. for 20 seconds to obtain an adhesive film. A 18-μm rolled copper foil (BHY-22B-T, produced by Japan Energy Corporation) was disposed on each surface of the adhesive film, and a protective material (Apical 125NPI produced by Kaneka Corporation) was applied on each copper foil on the surface to form a composite. The composite was subjected to continuous hot roll lamination at a polyimide film tension of 0.4 N/cm, a lamination temperature of 330° C., a lamination pressure of 196 N/cm (20 kgf/cm), and a lamination rate of 1.5 m/min to prepare a flexible metal-clad laminate of the present invention.

### Comparative Example 5

An adhesive film and a flexible metal-clad laminate were prepared as in EXAMPLE 26 except that the polyimide film obtained in EXAMPLE 14 was used instead of the polyimide film obtained in EXAMPLE 11.

### Comparative Example 6

An adhesive film and a flexible metal-clad laminate were prepared as in EXAMPLE 31 except that the polyimide film obtained in EXAMPLE 14 was used instead of the polyimide film obtained in EXAMPLE 11.

The evaluation results of the properties of the flexible metal-clad laminates obtained in EXAMPLES 26 to 33 and COMPARATIVE EXAMPLES 5 and 6 are shown in Table 13.

TABLE 1

| | Residual | First | Second | Third | IR | |
|---|---|---|---|---|---|---|
| | component | furnace | furnace | furnace | furnace | |
| | ratio (%) | (° C.) | (° C.) | (° C.) | (° C.) | Slow-cooling furnace |
| EXAMPLE 1 | 54 | 177 | 324 | 450 | 570 | 520, 460, 410, 350, 290, 240 |
| EXAMPLE 2 | 54 | 177 | 324 | 450 | 570 | 520, 460, 410, 350, 290, 240 |
| EXAMPLE 3 | 54 | 180 | 330 | 450 | 570 | 520, 460, 410, 350, 290, 240 |
| EXAMPLE 4 | 54 | 280 | 400 | 450 | 570 | 520, 460, 410, 350, 290, 240 |
| COMPARATIVE | 54 | 350 | 400 | 450 | 570 | 520, 460, 410, 350, 290, 240 |
| EXAMPLE 1 | | | | | | |
| Retention time | 160 | 30 | 30 | 20 | 60 | 40 |
| (sec) | | | | | | |

TABLE 2

| | Contraction/expansion ratio | | | | | | | | | | |
|---|---|---|---|---|---|---|---|---|---|---|---|
| | Hot-blast furnace | | | | | | | | | | |
| | First | Second | Third | IR | MOR-c | | | | | | |
| | furnace | furnace | furnace | furnace | A | B | C | D | E | F | G |
| EXAMPLE 1 | −4.4 | 0.0 | 4.4 | 0.0 | 1.55 | 1.29 | 1.31 | 1.25 | 1.37 | 1.35 | 1.36 |
| EXAMPLE 2 | −4.4 | 0.0 | 2.2 | 0.0 | 1.54 | 1.43 | 1.55 | 1.49 | 1.56 | 1.45 | 1.43 |
| EXAMPLE 3 | −4.4 | 0.0 | 0.0 | 0.0 | 1.42 | 1.58 | 1.66 | 1.70 | 1.66 | 1.57 | 1.43 |
| EXAMPLE 4 | −4.4 | 0.0 | 0.0 | 0.0 | 1.59 | 1.67 | 1.72 | 1.72 | 1.76 | 1.54 | 1.58 |
| COMPARATIVE | 0.0 | 0.0 | 0.0 | 0.0 | 1.77 | 1.34 | 1.19 | 1.04 | 1.21 | 1.31 | 1.78 |
| EXAMPLE 1 | | | | | | | | | | | |

| | Angle (°) | | | | | | | Difference in MOR |
|---|---|---|---|---|---|---|---|---|
| | A | B | C | D | E | F | G | (maximum − minimum) |
| EXAMPLE 1 | −5 | −8 | −16 | −1 | −1 | 2 | 19 | 0.30 |
| EXAMPLE 2 | 0 | −4 | −5 | −3 | −4 | −1 | 6 | 0.13 |
| EXAMPLE 3 | −3 | −2 | −7 | −6 | −6 | −6 | 11 | 0.28 |
| EXAMPLE 4 | −16 | −2 | −1 | −6 | −7 | −1 | 18 | 0.22 |
| COMPARATIVE | −35 | 23 | 40 | −88 | −39 | −39 | 35 | 0.74 |
| EXAMPLE 1 | | | | | | | | |

TABLE 3

| | Residual | First | Second | Third | Fourth | | |
|---|---|---|---|---|---|---|---|
| | component | furnace | furnace | furnace | furnace | IR furnace | Slow-cooling |
| | ratio (%) | (° C.) | (° C.) | (° C.) | (° C.) | (° C.) | furnace (° C.) |
| EXAMPLES 5 & 6 AND | 60 | 130 | 260 | 360 | 450 | 520 | 490, 465, 350 |
| COMPARATIVE | | | | | | | |
| EXAMPLE 2 | | | | | | | |
| Retention time (sec) | 220 | 50 | 50 | 50 | 50 | 70 | 200 |

TABLE 4

| | Contraction/expansion ratio | | | | | | | |
|---|---|---|---|---|---|---|---|---|
| | Hot-blast furnace | | | MOR-c | | | | |
| | First furnace | Fourth furnace | IR furnace | A | B | C | D | E |
| EXAMPLE 5 | −3.9 | 0.0 | 0.0 | 1.69 | 1.52 | 1.41 | 1.54 | 1.69 |
| EXAMPLE 6 | −3.9 | 3.9 | 0.0 | 1.46 | 1.31 | 1.31 | 1.33 | 1.36 |
| COMPARATIVE | 0.0 | 0.0 | 0.0 | 1.36 | 1.13 | 1.00 | 1.17 | 1.50 |
| EXAMPLE 2 | | | | | | | | |

| | Angle (°) | | | | | Difference in MOR |
|---|---|---|---|---|---|---|
| | A | B | C | D | E | (maximum − minimum) |
| EXAMPLE 5 | −4 | −5 | −8 | −11 | −13 | 0.28 |
| EXAMPLE 6 | −5 | 1 | 6 | 3 | 8 | 0.15 |
| COMPARATIVE | −17 | −30 | −48 | 29 | 26 | 0.50 |
| EXAMPLE 2 | | | | | | |

TABLE 5

| | Residual | First | Second | Third | IR | |
|---|---|---|---|---|---|---|
| | component ratio | furnace | furnace | furnace | furnace | Slow-cooling |
| | (%) | (° C.) | (° C.) | (° C.) | (° C.) | furnace (° C.) |
| EXAMPLE 7 | 23 | 350 | 400 | 450 | 410 | 410, 350, 290, 240 |
| Retention time | 160 | 30 | 30 | 20 | 60 | 40 |
| (sec) | | | | | | |
| EXAMPLE 8 | 23 | 350 | 400 | 450 | 410 | 410, 350, 290, 240 |
| Retention time | 160 | 30 | 30 | 20 | 60 | 40 |
| (sec) | | | | | | |
| EXAMPLE 9 | 30 | 260 | 370 | 450 | 350 | 410, 350, 290, 240 |
| Retention time | 160 | 30 | 30 | 20 | 60 | 40 |
| (sec) | | | | | | |
| EXAMPLE 10 | 30 | 250 | 370 | 450 | 350 | 410, 350, 290, 240 |
| Retention time | 160 | 30 | 30 | 20 | 60 | 40 |
| (sec) | | | | | | |

| | Post treatment (° C.) | | | | |
|---|---|---|---|---|---|
| | Hot-blast | IR | Post treatment | Post treatment | Post treatment |
| | furnace | furnace | retention time (sec) | tension (kg/m) | tension (kg/mm²) |
| EXAMPLE 7 | | | | | |
| Retention time | | 500 | 30 | 6.1 | 0.34 |
| (sec) | | | | | |
| EXAMPLE 8 | | | | | |
| Retention time | 470 | | 30 | 12.7 | 0.71 |
| (sec) | | | | | |
| | Hot blast/IR furnace | | | | |
| EXAMPLE 9 | | | | | |
| Retention time | 510 | | 45 | 12.7 | 0.51 |
| (sec) | | | | | |
| EXAMPLE 10 | | | | | |
| Retention time | 510 | | 45 | 13.5 | 0.54 |
| (sec) | | | | | |

TABLE 6

| | MOR-c | | | | | | |
|---|---|---|---|---|---|---|---|
| | A | B | C | D | E | F | G |
| EXAMPLE 7 | 1.84 | 1.84 | 1.86 | 1.80 | 1.80 | 1.79 | 1.82 |
| EXAMPLE 8 | 1.45 | 1.41 | 1.34 | 1.32 | 1.44 | 1.38 | 1.43 |
| EXAMPLE 9 | 2.13 | 2.24 | 2.11 | 2.21 | 2.2 | 2.3 | 2.25 |
| EXAMPLE 10 | 2.81 | 2.59 | 2.70 | 2.84 | 2.61 | 2.77 | 2.63 |

| | | | | | | | | Difference |
|---|---|---|---|---|---|---|---|---|
| | | | | | | | | in MOR |
| | Angle (°) | | | | | | | (maximum − |
| | A | B | C | D | E | F | G | minimum) |
| EXAMPLE 7 | −8 | −9 | −8 | −7 | 4 | −2 | −6 | 0.07 |
| EXAMPLE 8 | −12 | −12 | −11 | −9 | 2 | −5 | 0 | 0.13 |
| EXAMPLE 9 | −2 | −1 | −3 | −3 | 0 | 2 | 1 | 0.19 |
| EXAMPLE 10 | 1 | −1 | −3 | −3 | 0 | 1 | −1 | 0.25 |

TABLE 7

| | | Dimension (%) | | | |
|---|---|---|---|---|---|
| | | After etching | | | |
| Type of film | Portion of the film used | MD | TD | R | L |
| EXAMPLE 16 | Film end, position A | −0.03 | −0.04 | −0.01 | −0.06 |
| | Film center, position D | −0.03 | −0.03 | −0.03 | −0.03 |
| | Film end, position G | −0.03 | −0.04 | −0.01 | −0.06 |
| EXAMPLE 17 | Film end, position A | −0.03 | −0.05 | −0.04 | −0.04 |
| | Film center, position D | −0.02 | −0.06 | −0.05 | −0.04 |
| | Film end, position G | −0.04 | −0.04 | −0.06 | −0.02 |
| EXAMPLE 18 | Film end, position A | −0.03 | −0.02 | −0.02 | −0.04 |
| | Film center, position D | −0.02 | −0.01 | −0.03 | −0.02 |
| | Film end, position G | 0.01 | −0.04 | −0.04 | −0.04 |
| EXAMPLE 19 | Film end, position A | −0.03 | −0.04 | −0.01 | −0.06 |
| | Film center, position D | 0.03 | −0.06 | −0.02 | −0.02 |
| | Film end, position G | −0.04 | −0.04 | −0.06 | −0.02 |
| COMPARATIVE | Film end, position A | −0.03 | −0.02 | 0.10 | −0.09 |
| EXAMPLE 3 | Film center, position D | 0.00 | 0.03 | 0.05 | −0.03 |
| | Film end, position G | −0.04 | 0.02 | −0.10 | 0.07 |

TABLE 8

| | | Dimension (%) | | | |
|---|---|---|---|---|---|
| | | After etching | | | |
| Type of film | Portion of the film used | MD | TD | R | L |
| EXAMPLE 20 | Film end, position A | −0.03 | 0.01 | 0.03 | −0.01 |
| | Film center, position C | −0.04 | −0.04 | −0.05 | −0.03 |
| | Film end, position E | −0.03 | −0.02 | −0.02 | −0.03 |
| EXAMPLE 21 | Film end, position A | −0.04 | 0.00 | −0.01 | −0.01 |
| | Film center, position C | −0.04 | 0.00 | −0.02 | −0.02 |
| | Film end, position E | −0.02 | 0.01 | −0.02 | 0.00 |
| COMPARATIVE | Film end, position A | −0.05 | −0.02 | 0.10 | −0.09 |
| EXAMPLE 4 | Film center, position C | −0.06 | 0.03 | −0.03 | 0.00 |
| | Film end, position E | −0.04 | 0.01 | −0.12 | 0.10 |

TABLE 9

| | | Dimension (%) | | | |
|---|---|---|---|---|---|
| | | Afler etching | | | |
| Type of film | Portion of the film used | MD | TD | R | L |
| EXAMPLE 22 | Film end, position A | −0.04 | −0.03 | −0.05 | 0.01 |
| | Film center, position D | −0.05 | 0.01 | −0.04 | −0.02 |
| | Film end, position G | −0.02 | 0.00 | −0.05 | 0.01 |
| EXAMPLE 23 | Film end, position A | −0.03 | −0.05 | −0.04 | −0.02 |
| | Film center, position D | −0.03 | 0.01 | −0.03 | −0.03 |
| | Film end, position G | −0.04 | −0.03 | −0.04 | −0.01 |
| EXAMPLE 24 | Film end, position A | −0.12 | 0.02 | −0.06 | −0.05 |
| | Film center, position D | −0.10 | 0.00 | −0.05 | −0.00 |
| | Film end, position G | −0.12 | 0.01 | −0.05 | −0.04 |
| EXAMPLE 25 | Film end, position A | −0.04 | −0.05 | −0.06 | −0.04 |
| | Film center, position D | −0.05 | −0.05 | −0.05 | −0.03 |
| | Film end, position G | −0.05 | −0.05 | −0.05 | 0.00 |

TABLE 10

| | Atmospheric temperature (° C.) | | | | |
|---|---|---|---|---|---|
| | First | Second | Third | | |
| | furnace | furnace | furnace | IR furnace | |
| | (° C.) | (° C.) | (° C.) | (° C.) | Slow-cooling furnace (° C.) |
| EXAMPLE 11 | 160 | 300 | 450 | 570 | 520, 460, 410, 350, 290, 240 |
| EXAMPLE 12 | 170 | 300 | 450 | 570 | 520, 460, 410, 350, 290, 240 |
| EXAMPLE 13 | 180 | 330 | 450 | 570 | 520, 460, 410, 350, 290, 240 |
| EXAMPLE 14 | 350 | 400 | 450 | 570 | 520, 460, 410, 350, 290, 240 |
| Retention time | 25 | 25 | 20 | 20 | 60 |
| (sec) | | | | | |

TABLE 11

| | Expansion/contraction ratio (%) | | | | Molecular orientation | | | | | | |
|---|---|---|---|---|---|---|---|---|---|---|---|
| | Hot-blast furnace | | | | Upper column: MOR-c, Lower column: | | | | | | |
| | | Second | Third | IR | orientation angle | | | | | | |
| | First furnace | Furnace | furnace | furnace | A | B | C | D | E | F | G |
| EXAMPLE | Contraction | 0.0 | Expansion | 0.0 | 1.50 | 1.29 | 1.31 | 1.30 | 1.22 | 1.34 | 1.34 |
| 11 | 4.4 | | 4.4 | | −8 | −5 | −15 | 1 | 3 | 10 | 8 |
| EXAMPLE | Contraction | 0.0 | Expansion | 0.0 | 1.55 | 1.50 | 1.51 | 1.49 | 1.44 | 1.45 | 1.42 |
| 12 | 4.4 | | 2.2 | | 2 | −2 | 0 | −3 | 1 | 6 | 2 |
| EXAMPLE | Contraction | 0.0 | 0.0 | 0.0 | 1.58 | 1.66 | 1.70 | 1.70 | 1.69 | 1.54 | 1.60 |
| 13 | 4.4 | | | | 5 | −5 | 15 | 2 | 0 | −19 | 0 |
| EXAMPLE | 0.0 | 0.0 | 0.0 | 0.0 | 1.77 | 1.34 | 1.19 | 1.04 | 1.21 | 1.30 | 1.75 |
| 14 | | | | | −45 | 20 | 40 | 0 | −40 | −50 | 33 |
| EXAMPLE | 0.0 | 0.0 | 0.0 | 0.0 | 1.85 | 1.80 | 1.79 | 1.75 | 1.80 | 1.77 | 1.77 |
| 15 | | | | | −8 | −9 | −10 | 5 | 0 | −6 | 11 |

TABLE 12

| | Atmospheric temperature (° C.) | | | | | | Post | Post |
|---|---|---|---|---|---|---|---|---|
| | First | Second | Third | IR | | Post treatment | treatment | treatment |
| | furnace | furnace | furnace | furnace | Slow-cooling | temperature | tension | tension |
| | (° C.) | (° C.) | (° C.) | (° C.) | furnace (° C.) | (° C.) | (kg/m) | (kg/mm²) |
| EXAMPLE 15 | 350 | 400 | 450 | 410 | 410, 350, 290, | 500 | 6.1 | 0.33 |
| | | | | | 240 | | | |
| Retention time | 25 | 25 | 20 | 20 | 60 | 30 | | |
| (sec) | | | | | | | | |

TABLE 13

| | | | | | Dimensional change | | | | | |
|---|---|---|---|---|---|---|---|---|---|---|
| | | | Bonding | | After | | After | | | |
| | Polyimide | | strength | Sampling | etching | | heating | | Accumulation | |
| | film | Adhesive | (N/cm) | position | MD | TD | MD | TD | MD | TD |
| EXAMPLE 26 | EXAMPLE | SYNTHETIC | 9 | A | −0.03 | −0.03 | −0.03 | 0.05 | −0.06 | 0.02 |
| | 11 | EXAMPLE 2 | | B | −0.01 | −0.02 | −0.04 | 0.06 | −0.05 | 0.04 |
| | | | | C | −0.02 | −0.03 | −0.04 | 0.05 | −0.06 | 0.02 |
| EXAMPLE 27 | EXAMPLE | SYNTHETIC | 9 | A | −0.02 | −0.06 | −0.02 | 0.04 | −0.04 | −0.02 |
| | 12 | EXAMPLE 2 | | B | −0.02 | −0.06 | −0.02 | 0.04 | −0.04 | −0.02 |
| | | | | C | −0.01 | −0.06 | −0.01 | 0.02 | −0.02 | −0.04 |
| EXAMPLE 28 | EXAMPLE | SYNTHETIC | 9 | A | 0.03 | −0.06 | −0.07 | 0.04 | −0.04 | −0.02 |
| | 13 | EXAMPLE 2 | | B | 0.03 | −0.05 | −0.05 | 0.06 | −0.02 | 0.01 |
| | | | | C | −0.01 | −0.06 | −0.04 | 0.04 | −0.05 | −0.02 |
| EXAMPLE 29 | EXAMPLE | SYNTHETIC | 9 | A | −0.03 | −0.02 | −0.01 | 0.05 | −0.04 | 0.03 |
| | 11 | EXAMPLE 3 | | B | −0.02 | −0.01 | −0.02 | 0.05 | −0.04 | 0.04 |
| | | | | C | −0.02 | −0.02 | −0.02 | 0.04 | −0.04 | 0.02 |
| EXAMPLE 30 | EXAMPLE | SYNTHETIC | 9 | A | −0.02 | −0.06 | −0.02 | 0.03 | −0.04 | −0.03 |
| | 12 | EXAMPLE 3 | | B | −0.03 | −0.05 | −0.02 | 0.03 | −0.05 | −0.02 |
| | | | | C | −0.02 | −0.04 | −0.03 | 0.02 | −0.05 | −0.02 |
| EXAMPLE 31 | EXAMPLE | SYNTHETIC | 9 | A | 0.02 | −0.06 | −0.07 | 0.04 | −0.05 | −0.02 |
| | 13 | EXAMPLE 3 | | B | 0.00 | −0.06 | −0.06 | 0.03 | −0.06 | −0.03 |
| | | | | C | 0.00 | −0.05 | −0.05 | 0.03 | −0.05 | −0.02 |
| EXAMPLE 32 | EXAMPLE | SYNTHETIC | 9 | A | −0.05 | 0.01 | 0.01 | 0.02 | −0.04 | 0.03 |
| | 15 | EXAMPLE 2 | | B | −0.06 | 0.02 | 0.00 | 0.02 | −0.06 | 0.04 |
| | | | | C | −0.06 | 0.02 | 0.01 | 0.03 | −0.05 | 0.05 |
| EXAMPLE 33 | EXAMPLE | SYNTHETIC | 9 | A | −0.04 | 0.00 | 0.00 | 0.02 | −0.04 | 0.02 |
| | 15 | EXAMPLE 3 | | B | −0.04 | 0.01 | −0.01 | 0.03 | −0.05 | 0.04 |
| | | | | C | −0.03 | 0.00 | −0.01 | 0.02 | −0.04 | 0.02 |
| COMPARATIVE | EXAMPLE | SYNTHETIC | 9 | A | −0.06 | 0.02 | −0.20 | 0.08 | −0.26 | 0.10 |
| EXAMPLE 5 | 14 | EXAMPLE 2 | | B | −0.07 | 0.03 | −0.20 | 0.08 | −0.27 | 0.11 |
| | | | | C | −0.06 | 0.01 | −0.22 | 0.09 | −0.28 | 0.10 |
| COMPARATIVE | EXAMPLE | SYNTHETIC | 9 | A | −0.06 | 0.03 | −0.02 | 0.10 | −0.08 | 0.13 |
| EXAMPLE 6 | 14 | EXAMPLE 3 | | B | −0.06 | 0.05 | −0.03 | 0.11 | −0.09 | 0.16 |
| | | | | C | −0.07 | 0.04 | −0.05 | 0.11 | −0.12 | 0.15 |

What is claimed is:

1. An organic insulating film produced by a continuous process, the organic insulating film satisfying the following requirements (1) to (3) across the entire width of the film:
(1) the MOR-c of the film is 1.05 to 5.0;
(2) the orientation angle of a molecular chain main axis is 30 to 30 degrees with respect to a MD direction; and
(3) the difference between the maximum MOR-c and the minimum MOR-c of the film is 1.0 or less.

2. The organic insulating film according to claim 1, wherein the organic insulating film is a polyimide film.

3. The organic insulating film according to claim 2, wherein the polyimide film comprises a polyimide resin having at least one repeating unit selected from those represented by general formulae (1) and/or (2): 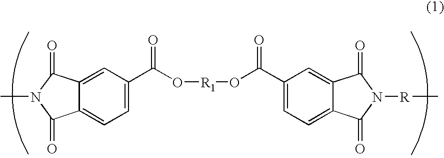
wherein R₁ represents a divalent organic group selected from the group consisting of: 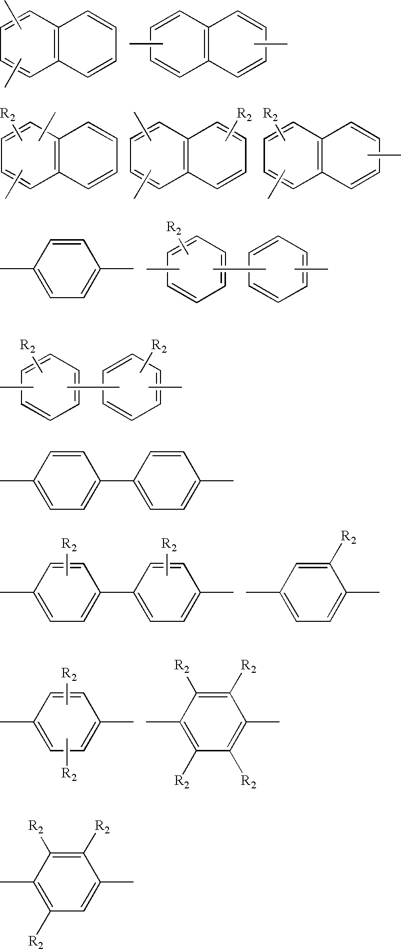
(wherein R²s each represent —CH₃, Cl, —Br, —F, or —OCH₃), and R represents a divalent organic group represented by 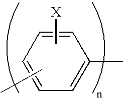
(wherein n represents an integer between 1 to 3; X represents a monovalent substituent selected from the group consisting of hydrogen, halogen, a carboxyl group, a lower alkyl group having 6 or less carbon atoms, and a lower alkoxyl group having 6 or less carbon atoms) and/or 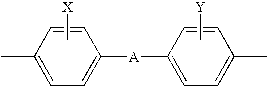
(wherein Y and Z each represent a monovalent substituent selected from the group consisting of hydrogen, halogen, a carboxyl group, a lower alkyl group having 6 or less carbon atoms, and a lower alkoxyl group having 6 or less carbon atoms; and A represents a divalent bonding group selected from the group consisting of —O—, —S—, —CO—, SO₂—, and —CH₂—); and 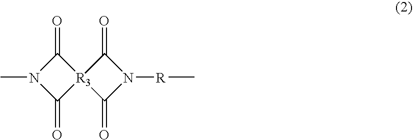
(wherein R is the same above and R3 represents a tetravalent organic group selected from the group consisting of the following:

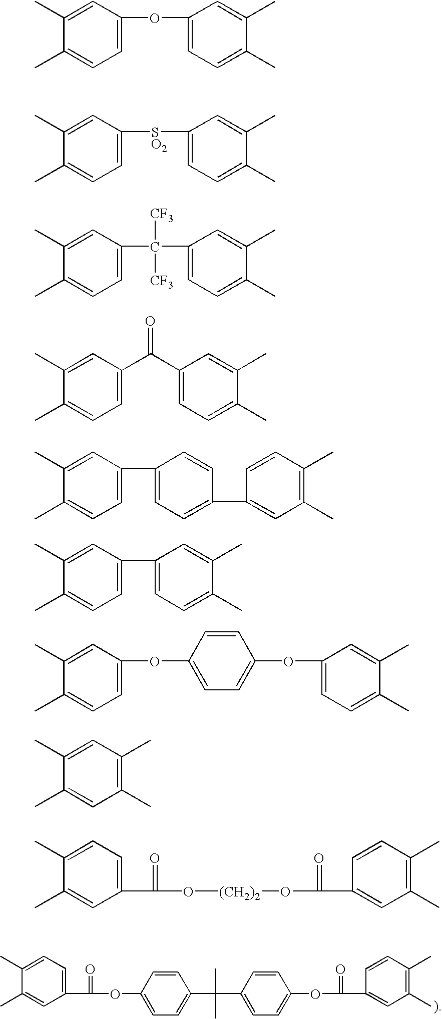

4. The organic insulating film according to claim 1, wherein the organic insulating film is produced by the steps (A) to (C):
(A) continuously flow-casting and applying a composition containing a polymer and an organic solvent onto a support to prepare a gel film;
(B) peeling the gel film from the support and fixing the both ends of the gel film; and
(C) transferring the film through a heating furnace while fixing the ends of the film.

5. The organic insulating film according to claim 4, wherein the organic insulating film is a polyimide film and the polymer used in step (A) is a polyamic acid.

6. The organic insulating film according to claim 2, wherein the organic insulating film has a width of 500 mm or more and is produced by a continuous process.

7. A flexible metal-clad laminate comprising the organic insulating film according to claim 1.

8. A coverlay film comprising the organic insulating film according to claim 1.

9. A TAB tape comprising the organic insulating film according to claim 1.

10. A COF base tape comprising the organic insulating film according to of claim 1.

11. A multilayer flexible wiring board comprising the organic insulating film according to of claim 1.

12. An adhesive film comprising a polyimide film and an adhesive layer containing a thermoplastic polyimide and being disposed on at least one surface of the polyimide film, wherein the adhesive film is produced by a continuous process and the polyimide film is the polyimide film according to claims 2.

13. The adhesive film according to claim 12, wherein the adhesive film is a long film having a width of 250 mm or more.

14. The adhesive film according to claim 12, wherein the adhesive film is bonded with a metal foil by a continuous process of heating and pressuring is using one or more pairs of metal rollers.

15. A flexible metal-clad laminate obtained by bonding a metal foil onto the adhesive film according to claim 12.

16. A method for making an adhesive film including a polyimide film and an adhesive layer containing a thermoplastic polyimide and being disposed on at least one surface of the polyimide film, the method comprising making the adhesive film by a continuous process using the polyimide film according to of claim 2.

17. A method for making a flexible metal-clad laminate, comprising a step of bonding a metal foil onto the adhesive film according to claim 12 by a continuous process under heat and pressure.

18. The method according to claim 17, wherein a temperature for the bonding is 200° C. or more and at least 50° C. higher than the glass transition point (Tg) of the thermoplastic polyimide.

19. An adhesive film comprising a polyimide film and an adhesive layer containing a thermoplastic polyimide and being disposed on at least one surface of the polyimide film, wherein the adhesive film is produced by a continuous process and the polyimide film is the polyimide film according to claim 2 and is produced by the steps (A) to (C):
(A) continuously flow-casting and applying a composition containing a polymer and an organic solvent onto a support to prepare a gel film;
(B) peeling the gel film from the support and fixing the both ends of the gel film; and
(C) transferring the film through a heating furnace while fixing the ends of the film.

20. A flexible metal-clad laminate obtained by bonding a metal foil onto the adhesive film according to claim 19.
